(19) United States
(12) Patent Application Publication
(10) Pub. No.: US 2002/0065677 A1
(43) Pub. Date: May 30, 2002

(54) Computer implemented method of managing information disclosure statements

(75) Inventors: Jeffry J. Grainger, Portola Valley, CA (US); James R. Shay, Seattle, WA (US); Cecily Anne Snyder, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First to File, Inc., Menlo Park, CA

(21) Appl. No.: 09/919,787

(22) Filed: Jul. 31, 2001

Related U.S. Application Data
(63) Continuation-in-part of application No. 09/733,616, filed on Dec. 7, 2000.
(60) Provisional application No. 60/253,360, filed on Nov. 27, 2000.

(51) Int. Cl. G06F 17/60

(52) U.S. Cl. 705/1

(57) ABSTRACT

A computer implemented method of managing invention disclosure statements is described. In one embodiment, the computer-implemented method of the present invention includes storing a plurality of electronic documents in a database, associating a first one or more of the plurality of electronic documents to a first case, associating a second one or more of the plurality of electronic documents to a second case, receiving a select signal from a user, the select signal selecting at least one of the second one or more of the plurality of electronic documents associated with the second case to be associated with the first case, and associating the at least one of the second one or more of the plurality of electronic documents to the first case in response to the select signal. In one embodiment, the first case and second case are related cases.

### CROSS-REFERENCES TO RELATED APPLICATIONS

This application is a continuation-in-part of U.S. application Ser. No. 09/733,616, filed Dec. 7, 2000, entitled “COMPUTER IMPLEMENTED METHOD OF GENERATING INFORMATION DISCLOSURE STATEMENTS,” and listing Jeffry J. Grainger as inventor. This application also is related to U.S. application Ser. No. 09/585,947, filed Jun. 2, 2000, entitled “COMPUTER-IMPLEMENTED METHOD FOR SECURING INTELLECTUAL PROPERTY,” and listing Jeffry J. Grainger as inventor. This application is also related to U.S. application Ser. No. 09/585,989, filed Jun. 2, 2000, entitled “COMPUTER-IMPLEMENTED METHOD OF DOCKETING INTELLECTUAL PROPERTY FILINGS,” and listing Jeffrey J. Grainger as inventor. This application is also related to U.S. application Ser. No. 09/642,619, filed Aug. 17, 2000, entitled “COMPUTER-IMPLEMENTED METHOD OF DOCKETING INTELLECTUAL PROPERTY FILINGS,” and listing Jeffry J. Grainger as inventor. The disclosures of Ser. Nos. 09/585,947, 09/585,989, and 09/642,619 are hereby incorporated herein by reference in their entirety. This application is also related to U.S. Provisional Application No. 60/253,360, filed Nov. 27, 2000, entitled “DATA PROCESSING SYSTEM FOR MANAGING INTELLECTUAL PROPERTY ASSETS,” and listing Jeffry J. Grainger as inventor, which is also incorporated herein by reference in its entirety.

### BACKGROUND OF THE INVENTION

The present invention relates to managing intellectual property. More particularly, the present invention relates to a computer-implemented method of managing electronic documents associated with obtaining and maintaining intellectual property rights such as patent rights.

As the world economy has become more information and technology oriented, patents and other intellectual property are of growing importance. In order to secure such intellectual property rights appropriate paperwork needs to be completed and filed in an intellectual property office. For example, in order to secure patent protection within the United States, a patent application describing and claiming an invention needs to be filed in the United States Patent and Trademark Office (USPTO). Once filed, previously established rules and guidelines are followed by a Patent Examiner to determine whether or not patent rights to the invention should be granted. For example, in the United States one important rule requires that each individual associated with the filing and prosecution of a patent application has a duty of candor and good faith in dealing with the Patent Office, which includes the duty to disclose to the Office all information known to that individual to be material to patentability. Failure of an applicant to meet this requirement can in some cases lead to the invalidity of any patents that ultimately issues. Additionally, the patent systems of some foreign countries may also have requirements analogous U.S. duty to disclose.

Traditional methods of meeting the disclosure requirements in the USPTO have centered on the preparation and submission of an Information Disclosure Statement (“IDS”). Typically, a patentee or other individual associated with the filing and prosecution of a patent application who is aware of a prior art document that is material to patentability will fill out an IDS and submit the IDS in paper form to the USPTO. However, problems with the management and submission of IDS's often arise when a large number of individuals become associated with the filing and prosecution of a patent application. For example, a single application may involve one or more inventors, one or more in-house patent attorneys and/or patent managers, and one or more external patent attorneys responsible for various portions of the patenting process. As the number of individuals associated with the filing and prosecution of a patent application increases, the risk associated with failing to meet the disclosure requirements also increases.

Another problem associated with the management and submission of IDS's arises in the context of patent applications that are filed internationally. As previously mentioned, other patent systems have rules analogous to the U.S. duty of disclosure. Problems meeting international disclosure requirements can quickly become unmanageable when an organization such as a law firm or an internal patent group of a corporation is attempting to reconcile search reports and/or disclosure materials for a large number of inventions across multiple countries around the world. Further complicating matters, any prior art references cited by foreign patent offices must be disclosed to the USPTO in the corresponding U.S. Patent Application if it remains pending.

Therefore, the contemporary use of paper forms prepared by manual entry of information is inherently filled with risk and potential liability. Accordingly, improved methods of managing information disclosure statements for domestic and international patent filings is desirable.

### SUMMARY OF THE INVENTION

Embodiments of the present invention solve the problems described above with respect to previously known methods of managing information disclosure statements. Specifically, the present invention provides a computer-implemented method of managing electronic documents relating to invention disclosure statements. The method of the present invention reduces the likelihood that a known prior art reference document will erroneously go undisclosed to a patent office by an individual associated with the filing and prosecution of a patent applications.

In one embodiment, the computer-implemented method of the present invention includes storing a plurality of electronic documents in a database, associating a first one or more of the plurality of electronic documents to a first case, associating a second one or more of the plurality of electronic documents to a second case, receiving a select signal from a user, the select signal selecting at least one of the second one or more of the plurality of electronic documents associated with the second case to be associated with the first case, and associating the at least one of the second one or more of the plurality of electronic documents to the first case in response to the select signal. In one embodiment, the first case and second case are related cases.

Furthermore, in another embodiment, the invention further comprises displaying a third case and links to a third one or more of the plurality of electronic patent documents to a user, the third case being associate with the third one or more of the plurality of electronic patent documents.

These and other embodiments of the present invention, as well as its advantages and features, are describe in more detail in conjunction with the text below and attached figures.

### BRIEF DESCRIPTION OF THE DRAWINGS

FIG. 1 is a simplified diagram of an example of a hardware system according to one embodiment of the present invention.

FIG. 2 is a flowchart that illustrates a method of generating an electronic IDS according to one embodiment of the present invention.

FIG. 3A shows a web page that includes the results of a patent search to illustrate a method of generating an information disclosure statement according to another embodiment of the present invention.

FIG. 3B shows a patent web page containing reference information corresponding to a patent to illustrate a method of generating an information disclosure statement according to another embodiment of the present invention.

FIG. 4 illustrates a blank invention disclosure statement form typically used to meet the duty of disclosure requirement in the United States Patent and Trademark Office.

FIG. 5 is a flowchart that illustrates a method of generating an electronic IDS that will correspond to the IDS form of FIG. 4.

FIG. 6 is a diagram illustrating one technique for extracting information from a web page into an electronic IDS according to another embodiment of the present invention.

FIG. 7 is a diagram that illustrates incorporating documents from multiple web sites into a single electronic IDS according to another embodiment of the present invention.

FIG. 8 is a simplified diagram of an example of a hardware system according to another embodiment of the present invention.

FIG. 9 is a simplified diagram of an example of a hardware system according to another embodiment of the present invention.

FIG. 10 is a simplified diagram of an example of a hardware system according to another embodiment of the present invention.

FIG. 11 is a simplified block diagram showing the relationship between an intellectual property (IP) data processing system according to one embodiment of the present invention and participants in the patent process.

FIG. 12 illustrates a search web page that may be accessed by a user of IP data processing system for searching external web sites for reference documents which may include information to be submitted in an IDS according to one embodiment of the present invention.

FIG. 13A shows an exemplary Web page according to one embodiment of a trifold graphical user.

FIG. 13B is an example of a Web page that shows the contents of an office action package.

FIGS. 13C-D illustrates how data in the database may be organized in tables according to one embodiment of the present invention.

FIG. 14 illustrates a Case Reference List Web page according to one embodiment of the present invention.

FIG. 15 illustrates a case search Web according to one embodiment of the present invention.

FIG. 16 illustrates a case search result Web according to one embodiment of the present invention.

FIG. 17 illustrates an add group reference Web page 1700 according to one embodiment of the present invention.

FIG. 18 shows a case reference report Web page according to one embodiment of the present invention.

FIG. 19 illustrates an incoming mail queue Web page according to one embodiment of the present invention.

FIG. 20 illustrates a method of managing information disclosure statements according to one embodiment of the present invention.

FIG. 21 illustrates a method of managing information disclosure statements according to another embodiment of the present invention.

### DESCRIPTION OF THE SPECIFIC EMBODIMENTS

The present invention provides a computer-implemented method of managing information disclosure statements (“IDS”) associated with meeting the disclosure requirements for patent applications in a patent office. For convenience, the invention is described below with respect to managing information disclosure statements to be submitted to the United States Patent and Trademark Office (“USPTO”). It is to be understood, however, that the present invention is also useful for managing information disclosure statements necessary for meeting disclosure requirements of official patent offices in other countries.

As used herein, an “official patent office” is any patent office designated to receive patent filings for an individual country or collection of countries as provided for by various treaties or other compacts that countries may enter. Examples of official patent offices include but are not limited to the United States Patent and Trademark Office, the European Patent Office, the German Patent Office, the Japanese Patent Office and any designated receiving office for patent applications filed under the Patent Cooperation Treaty. The IDS management technique provided by the method of the present invention is useful for automatically managing the requisite documents required to meet the various disclosure requirements of any particular official patent office around the world.

The computer-implemented method of managing information disclosure statements according to the present invention enables users to search through a vast amount of potentially relevant prior art information accessible on a large network of computers, such as the internet, and identify relevant electronic documents for disclosure to a patent office. As used herein, the term electronic document refers at least to web pages or other computer files which are remotely accessible. Electronic documents may include U.S. Patent information, foreign patent information, publication information, or other information falling within a disclosure rule for a patent office, for example. Additionally, information included in such electronic documents is referred to herein as reference information.

Once a user has identified a relevant electronic document, embodiments of the present invention automatically extract relevant portions of the reference information from the electronic document into an electronic information disclosure statement (“electronic IDS”). The portion of the reference information relevant to an electronic IDS is referred to herein as IDS information. It is to be understood that the reference information in an electronic document may include some or all of the information necessary for including a particular prior art reference in an electronic IDS for disclosure to a patent office. IDS information as defined herein includes whatever portion of the reference information that is relevant to completing an invention disclosure to a patent office. Moreover, an electronic IDS may be an electronic file for storing IDS information extracted from an electronic document. Additionally, an electronic IDS, as referred to herein, may also be a electronic file storing a plurality of pointers. Each pointer may correspond to a relevant local or remote electronic document containing IDS information that must be submitted to an official patent office. Alternatively, in one embodiment, the electronic IDS is a electronic file for storing each relevant electronic document that must be submitted to an official patent office. In that case, the IDS information is filtered from the electronic IDS when the final Information Disclosure Statement is submitted. In yet another embodiment, the reference information or the entire electronic documents are stored in a database, and the electronic IDS is a file corresponding to a particular patent application that includes cross-references to particular documents stored in the database.

After the IDS information has been incorporated into the electronic IDS, the electronic IDS can then be transmitted manually or electronically to the pertinent official patent office. The electronic IDS can be stored on a particular user's computer, on a local server, or on a remote server. Accordingly, embodiments of the present invention drastically simplify the process of generating information disclosure statements, thereby reducing the likelihood that a person associated with the filing or prosecution of a patent application will fail to meet the duty of disclosure.

Additionally, embodiments of the present invention provide patent applicants with an easy way of searching for prior art and providing the prior art to an official patent office in an effort to increase the value of the patent that ultimately issues. Furthermore, other embodiments provide technologists with a way of searching a technical field for information and storing information that may be relevant to a future patent application into an electronic IDS. Moreover, in another embodiment, patent applicants or inventors may be provided with instructions on when a particular electronic document falls within the duty of disclosure, and therefore should be added to an electronic IDS.

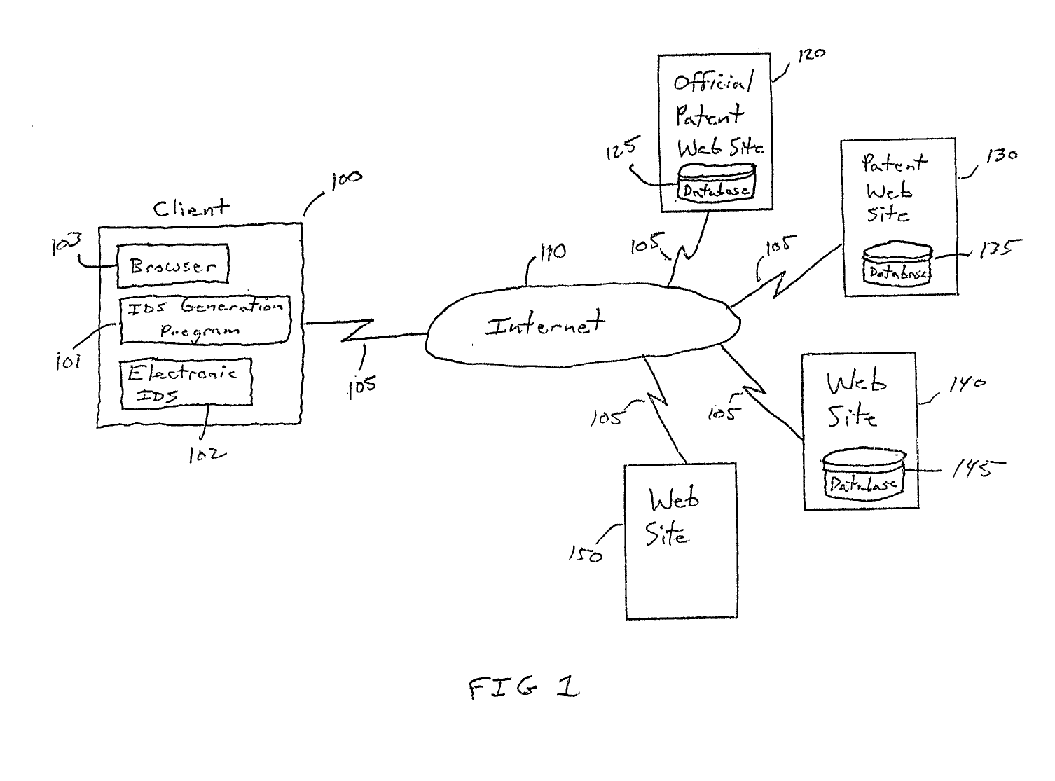

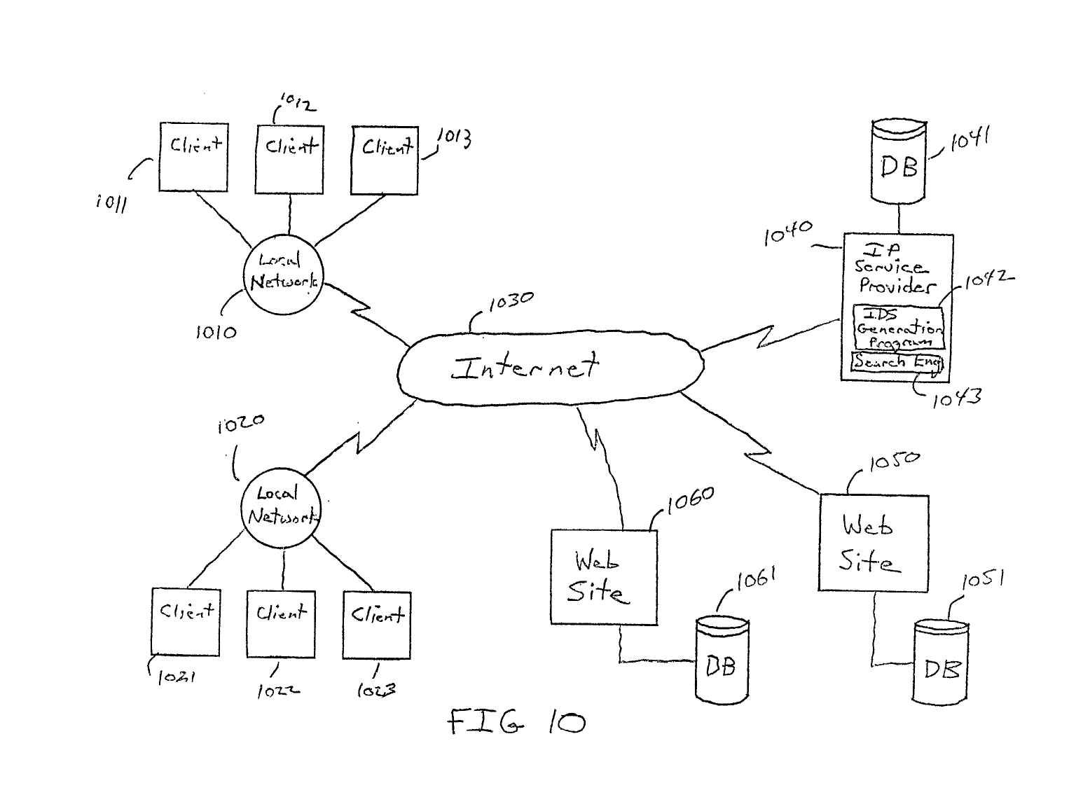

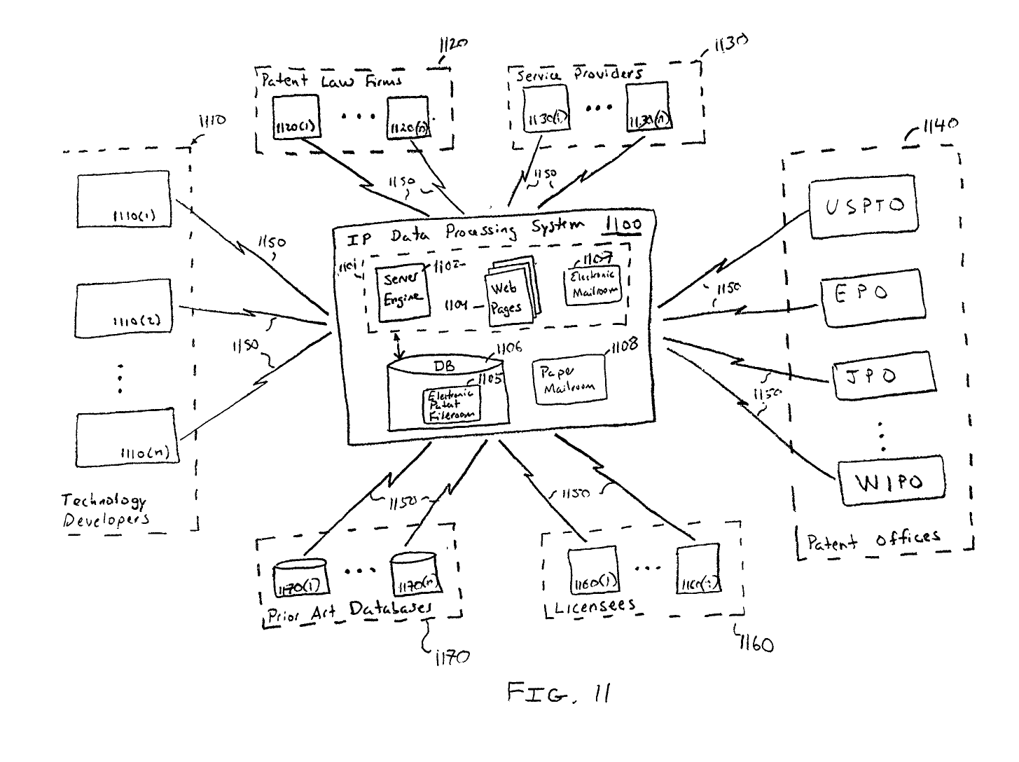

Among other techniques, embodiments of the present invention may be implemented by providing program code operating on a computer system that is connected to the internet as described below with respect to FIG. 1. In another embodiment, program code is included on multiple computer systems that are connected together and to a local database over a local network. The local network is then connected to the internet as illustrated FIG. 7. In another embodiment, the program code operates on a remote server as described below with respect to FIG. 9. In yet another embodiment, multiple local networks access a remote intellectual property (“IP”) service provider that includes program code for searching web sites for information and for automatically generating electronic IDS's as illustrated in FIG. 10.

FIG. 1 is a simplified, system-level diagram of an example of a hardware configuration that can be used to implement a first embodiment of the present invention. FIG. 1 includes a local client computer system 100 to be used by a user. The client system 100 is connected to the internet 110 over a communication link 105. The client system may also be connected to remote web sites 120, 130, 140, and 150 via the internet 110 and additional communication links 105. It is to be understood that the client computer systems, server computer systems, and the computer systems of the remote web sites typically include a computer processor and computer readable memory, coupled to said processor, (not shown) for storing programs and other software as is well know in the art.

Client system 100 includes an IDS generation program 101. IDS generation program 101 is used, for example, to create or update an electronic IDS 102 at the request of a user. Client system 100 also includes browser software 103. Browser software 103 may be either Netscape or Internet Explorer browsers, for example. Browser software 103 allows a user to access web sites 120, 130, 140, and 150. For example, in one embodiment a user may be an inventor with a new idea that he believes may be worth patenting. The user can activate IDS generation program 101, which may generate a new electronic IDS corresponding to a potential patent application. Next, the user can activate the browser 103 and search the internet for prior art documents. In another embodiment, the browser is integrated into the IDS generation program. Accordingly, when a user activates the IDS generation program, integrated browser capabilities allow the user to search the internet for prior art information.

Referring to FIG. 1, the user can activate browser 103 to access an official patent web site 120 over the internet 110. An official patent web site may be the official web site of an official patent office such as the USPTO, the European Patent Office, or the Japanese Patent Office. The user may then use browser 103 to search through a database 125 located on the official patent web site 120 for issued patents, published patents, or relevant publications.

Additionally, the user can activate browser 103 to access a patent web site 130 over the internet 110. A patent web site may be a privately operated web site containing a database 135 of patent related materials (e.g. such as MicroPatent or the Delphion Intellectual Property Network). The user may then use browser 103 to search through a database 135 located on the patent web site 130 for issued patents, published patents, or relevant publications.

Moreover, the user can connect to other web sites 140 over the internet 110 that contain databases 145 of general information that may include issued patents, published patents, technical publications, articles, or internet publications relevant to a future or pending patent application. These may be fee services such as LEXIS, DIALOG, or WESTLAW, or alternatively, free services such as “search.stanford.edu” or other remotely accessible databases containing free potential prior art information. The user may then use browser 103 to search through a database 145 located on the web site 140 for any relevant publications the need to be disclosed to a patent office.

Furthermore, FIG. 1 illustrates that a user can search a web site 150 over the internet for any information that may be relevant to a future or pending patent application.

For example, if the user is planning on filing, or has already filed, a patent application relating to a method of providing an on-line auction, the user may search internet web sites for existing on-line auction web sites. The user can then disclose prior art on-line auction web sites that may be relevant to the future or pending patent application by disclosing to the examiner the name, web address, and relevant web pages of the prior art sites.

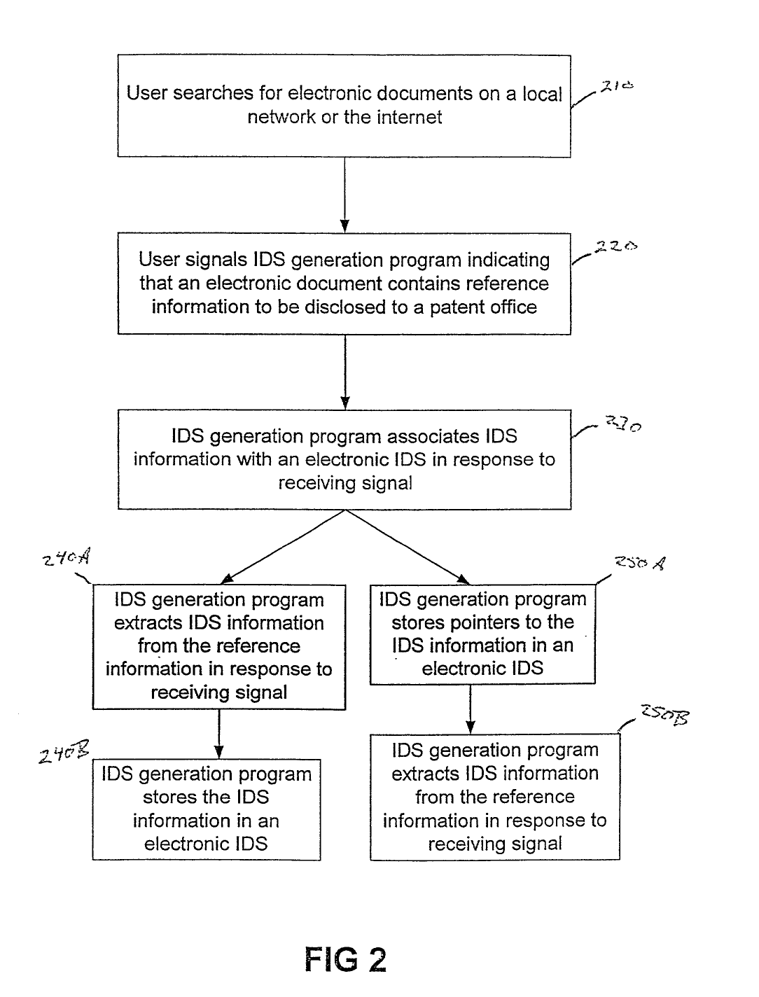

FIG. 2 is a flowchart that illustrates a method of generating an electronic IDS according to one embodiment of the present invention. At step 210, a user searches for electronic documents on a local network or on a remote network such as the internet.

Referring to FIG. 1, a user could search for electronic documents on various web sites 120, 130, 140, or 150 from client system 100 over internet 110. In one embodiment, the user searches various web sites using browser 103, and IDS generation program 101 is running in parallel with the browser. In another embodiment, IDS generation program is included as part of a larger remotely operating IP service provider web site, as described in more detail below. The IP service provider web site may include an IDS generation program and a search engine that are fully integrated into the site, and allow a user to search databases connected to the IP service provider web site as well as other databases connected to the internet.

At step 220, the user signals an IDS generation program indicating that an electronic document has been found that contains reference information to be disclosed to a patent office. For example, the reference information could be in an electronic patent document or electronic version of a printed publication. The IDS generation program provides a prompt to the user for generating a signal to the IDS generation program when the user has identified an electronic document to be disclosed to a patent office. In one embodiment, the prompt is provided by modifying the right-click mouse pop-up window to include an additional field. An additional field in the pop-up menu may display “save as IDS”. When the user has identified a relevant electronic document, the user may activate the pop-up window and select “save as IDS.” Selecting this menu option will signal the IDS generation program that the user has identified a relevant document that is to be disclosed to a patent office. The signal may cause the current document in the browser to be included in the electronic IDS, for example. In another embodiment, the prompt is an electronic button on the users computer screen. When a user identifies an electronic document to be disclosed to a patent office, the user may simply click the electronic button to signal IDS generation program to include the electronic document in an electronic IDS. Additionally, in another embodiment, the prompt is a computer screen icon. When a user identifies an electronic document to be disclosed to a patent office, the user may simply click the icon to access the IDS generation program. In one embodiment, the user may simply click-and-drag a hypertext link corresponding to an electronic document to either the electronic button or the computer screen icon to cause the electronic document to be included in an electronic IDS.

In one embodiment, the IDS generation program is included as part of a larger remotely operating IP service provider web site. An electronic button is provided as part of the IP service provider web site so that when a user identifies a document to be disclosed to a patent office, the user simply mouse clicks the electronic button to signal the IDS generation program that an electronic document containing reference information to be disclosed to a patent office has been identified.

At step 230, IDS generation program associates IDS information with an electronic IDS in response to receiving the users signal at step 230. FIG. 2 illustrates two exemplary methods that may be used to associate the IDS information with an electronic IDS.

According to one embodiment, at 240A the IDS generation program extracts the IDS information from the reference information in response to receiving the signal. Then at step 240B the IDS generation program stores the IDS information in an electronic IDS. In another embodiment, at 250A the IDS generation program stores a plurality of pointers to the IDS information in an electronic IDS. Then at step 250B, the IDS generation program extracts IDS information from the reference information in the electronic document referenced by the pointer in response to receiving a later received signal. For example, the user may search the internet and each time a relevant reference is identified, a pointer to the reference may be stored into the electronic IDS by pressing an electronic button or menu option. Then, when the user is ready to file the electronic IDS in the patent office, the user signals the IDS program to carry out the filing. In response to the filing signal, the IDS generation program extracts the IDS information from the reference information in each electronic document referenced by a pointer in the electronic IDS. The IDS information is automatically compiled and transmitted to a patent office. Alternatively, if electronic submission is unavailable, the signal may indicate that the user desires to print out the IDS information.

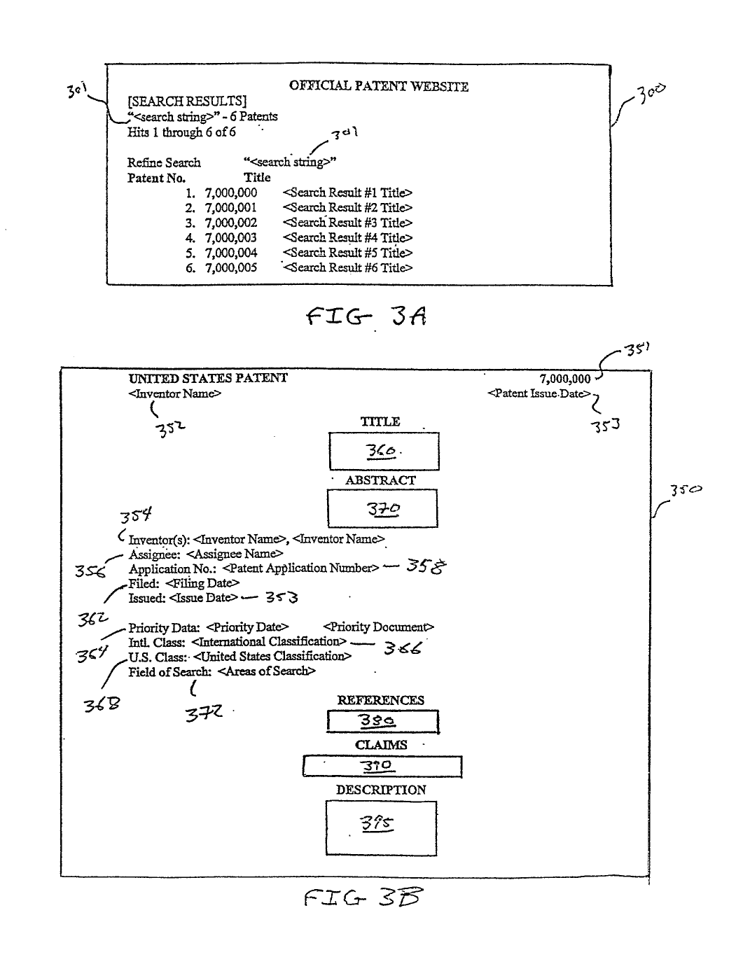

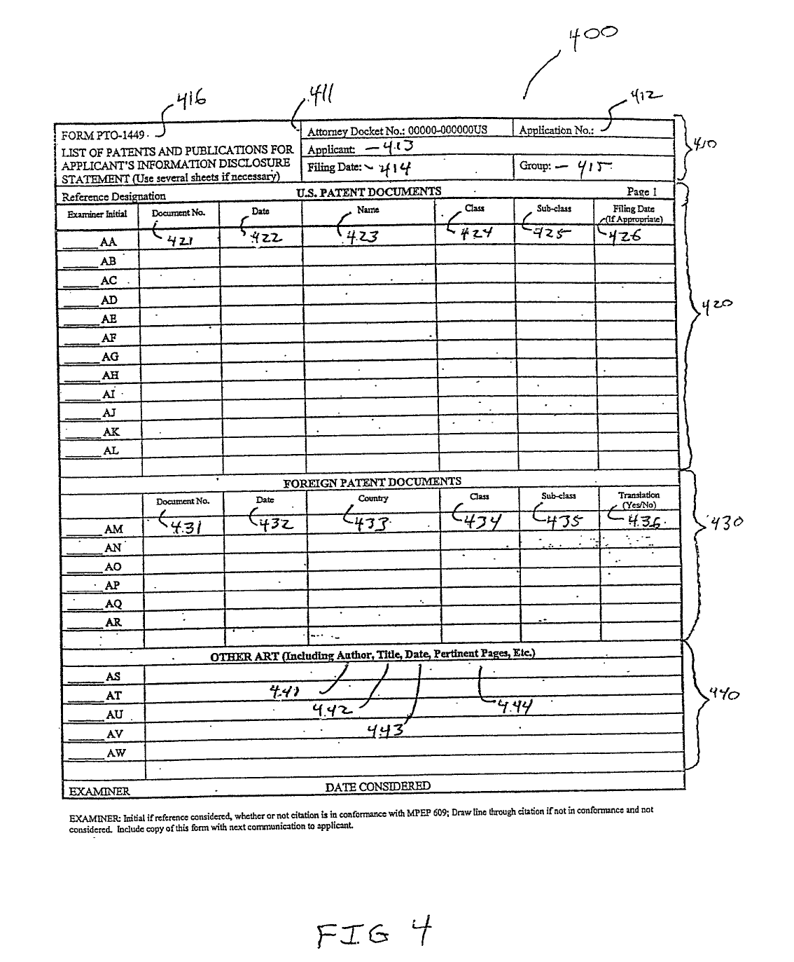

The embodiment of FIG. 2 is further illustrated by FIG. 3A. FIG. 3A illustrates a web page that shows the results of an exemplary patent search carried out at step 210 of FIG. 2 on an official patent web site 120. Search results 300 are in response to a search string 301. For the example shown in FIG. 3A, six patents were found in database 125 of web site 120 in response to a search string 301. Typically, the six patent numbers and/or titles will be in the form of hypertext links as is well known in the art. A user can point a mouse controlled pointer over either the patent number (i.e. 7,000,000 through 7,000,005) or the titles <Search Result #1-6 Title> and click the mouse to access another web page with more information about the particular patent.

FIG. 3B illustrates a patent web page 350 that shows the electronic document containing the reference information corresponding to patent number 7,000,000 of FIG. 3A. In response to accessing one of the patents identified in the search result, an electronic document containing the patent reference information is downloaded to the user's computer system. The reference information in FIG. 3B includes the patent number 351, the first named inventor 352, the patent issue date 353, the title 360, the abstract 370, the complete list of inventors 354, the name of the assignee 356, the application number 358, the filing date 362, priority data 364, the international classification 366, the United States classification 368, the field of search 372, cited references 380, claims 390, and the description 395. Of course, other databases and/or search engines may provide a subset or superset of the above information corresponding to an issued patent. Additionally, published applications may also be found as a result of searches on official patent web sites 120 or patent web sites 130. Moreover, with the recent changes in U.S. Patent policy, published applications that have not yet issued as patents may contain a subset or superset of the above information and may be available on the USPTO web site in the future. Accordingly, FIGS. 3A and 3B are illustrative only.

It is important to point out that the above reference information made available as a result of a search on a web site may contain more information than is necessary for an electronic IDS. For the example illustrated in FIG. 3B, after identifying and downloading an issued patent that requires disclosure to a patent office, a user may signal IDS generation program to extract only that portion of the reference information necessary for completing an IDS. The program will then store the IDS information in the electronic IDS.

FIG. 4 illustrates a blank invention disclosure statement form (“IDS form”) 400 typically used to meet the duty of disclosure requirement in the USPTO. In accordance with one embodiment of the present invention, an electronic IDS 102 that includes all the information required in this form can be generated by IDS generation program 101. As illustrated by FIG. 4, an IDS form 400 generally includes four sections: a general information section 410, a United States Patent Documents section 420, a Foreign Patent Documents section 430, and a section for publications and articles entitled Other Art 440.

In one embodiment of the present invention, an electronic IDS is a computer file stored on a computer readable medium. The electronic IDS may include information corresponding to the general information section 410 of IDS form 400. The electronic IDS may include an attorney docket number corresponding to IDS form attorney docket number 411, application number corresponding to IDS form application number 412, applicant name corresponding to IDS form applicant 413, filing date corresponding to IDS form, filing date 414, group information corresponding to IDS form group 415, and document identification information corresponding to IDS form title 416.

Additionally, an electronic IDS may include information corresponding to U.S. Patent Documents section 420 of IDS form 400 of FIG. 4. An electronic IDS may include information corresponding to IDS form Document No. 421 (i.e. patent number), Date 422 (i.e. date of issuance), Name 423 (i.e. inventor name), Class 424 (i.e. technology classification), sub-class 425, and filing date 426. Moreover, an electronic IDS may include information corresponding to Foreign Patent Documents section 430 of IDS form 400. An electronic IDS may include information corresponding to IDS form Document No. 431, Date 432, Name 433, Class 434, Sub-class 435, and translation 436. Finally, an electronic IDS may include information corresponding to printed publications and other art section 440 of IDS form 400. An electronic IDS may include information corresponding to Author 441, Title 442, Date 443, and Pertinent Pages 444.

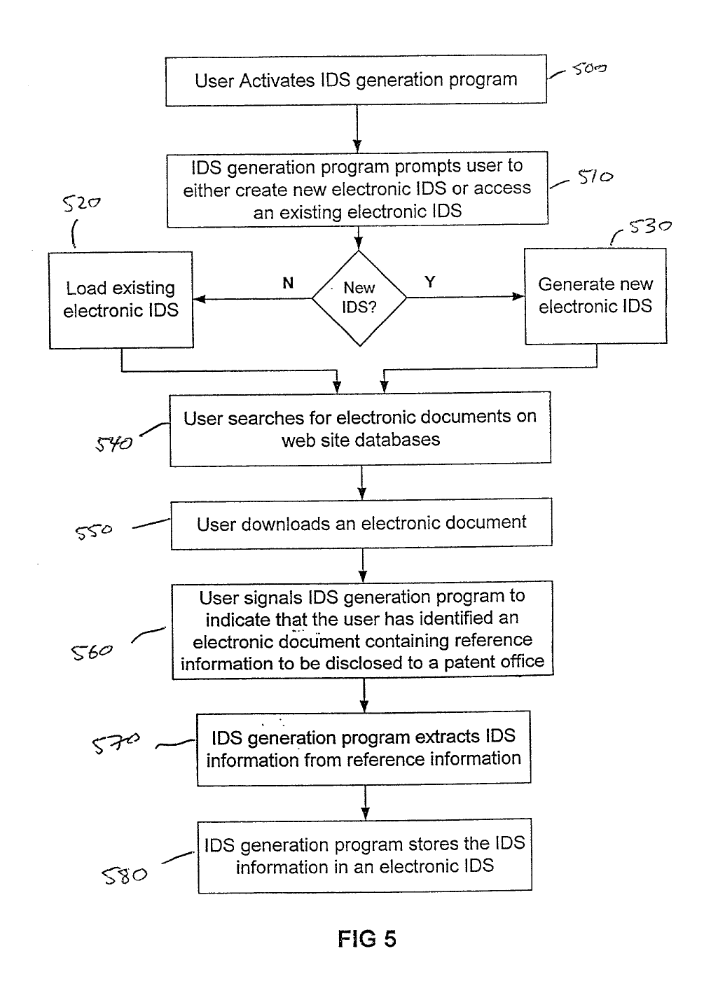

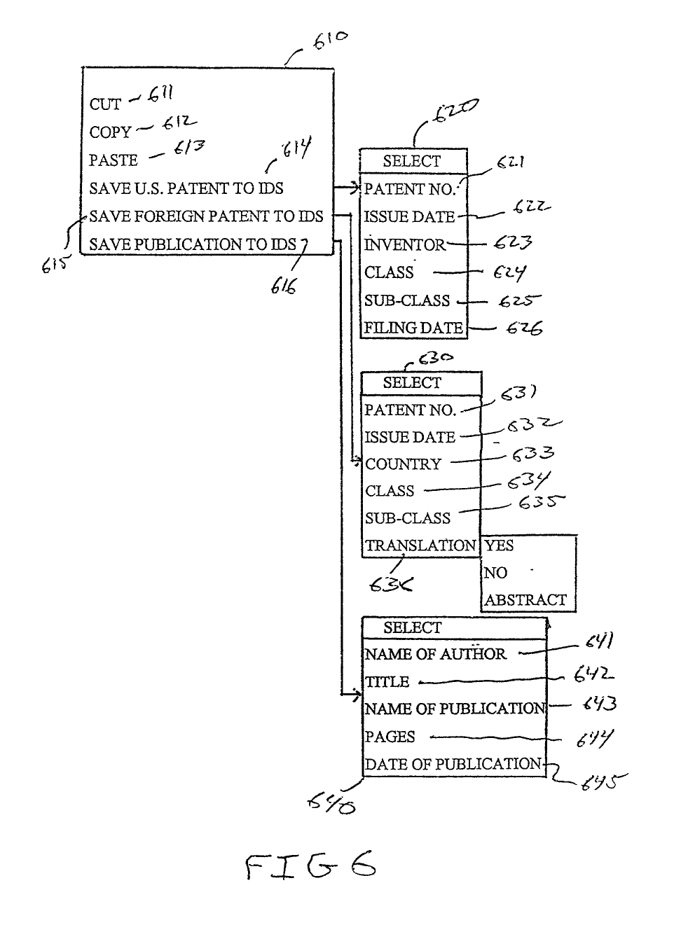

FIG. 5 is a flowchart that illustrates a method of generating an electronic IDS that will correspond to the IDS form 400 of FIG. 4. In step 500, a user activates the IDS generation program 101. The IDS generation program 101 is then loaded from a memory such as a hard disk drive (not shown) on the client system 100 and begins to run. After the IDS program 101 is loaded, it prompts the user to either create a new electronic IDS or access an existing electronic IDS at step 510. Of course, various methods for prompting the user are well known in the art and may include a menu system or pop up window, for example.

If the user accesses a existing electronic IDS, then the existing electronic IDS is loaded from memory at step 520. Step 520 may also include a prompt to the user to enter information identifying a particular electronic IDS to access. For example, the user may be asked to input either a reference number (e.g. an attorney docket number), title, or patent application number to identify the electronic IDS to be accessed. An additional step may be included in other embodiments that provide for the IDS generation program 101 to include program code which requires the user to enter identification information before being allowed access to an existing electronic IDS. Such security features may be useful to guarantee that only individuals associated with the filing and prosecution of a particular patent application will be allowed to modify an existing electronic IDS.

Alternatively, in other embodiments, a user of a IP services web site may access a case file for a patent application. The case file may include links to documents related to the particular patent application. Accordingly, a user may access an existing IDS by simply accessing a link in the case file. Alternatively, a user may create a new IDS for the case file by signaling the desire to create a new IDS, and the resulting new IDS is automatically associated with the particular case file.

On the other hand, if the user indicates that there is no currently existing electronic IDS, then at step 530 the IDS generation program generates a new electronic IDS.

According to one embodiment, the IDS generation program prompts the user to input a reference to identification information for a currently existing invention recorded in a database. For example, the IDS generation program may prompt the user to enter or select a reference number, title, or patent application number corresponding to an electronic record of an existing invention stored in a database. The electronic record may already contain the general information corresponding to section 410 of IDS form 400. After the user enters reference, such as the docket number or title, the IDS generation program then accesses the corresponding electronic record of the existing invention and copies the general information into a new electronic IDS. In accordance with general information section 410, IDS program 101 may automatically generate a new electronic IDS file and enter information corresponding to attorney docket number 411, application number 412, applicant 413, filing date 414, and group 415 of IDS form 400.

In another embodiment, when a new electronic IDS is to be created by IDS generation program 101 at step 530, the program prompts the user for the general information corresponding to general information section 410. In accordance with general information section 410, IDS program 101 may prompt the user to enter information corresponding to attorney docket number 411, application number 412, applicant 413, filing date 414, and group 415 of IDS form 400, for example. After a user has entered each piece of general information, IDS program 101 would then generate a new electronic IDS which would include such information.

Storing general information in an electronic IDS would be particularly useful in applications where a new electronic IDS was generated by a first user, for example an inventor, and then accessed later by other users such as the inventors technical manager, an in-house patent attorney, or an external patent attorney. Each user could access a particular electronic IDS by referencing one or more of the pieces of general information stored in each electronic IDS. Furthermore, such information is useful when printing and mailing or otherwise transmitting the electronic IDS to the USPTO.

At step 540 of FIG. 5, a user searches web sites on either a local network or a wide area network, such as the internet, for electronic documents to be disclosed to a patent office. For example, referring again to FIG. 1, a user may access an official patent web site 120 such as the Official United States Patent and Trademark Web Site and search through a database 125 of issued patents and/or patent publications. Alternatively, a user could search through web sites 130, 140, or 150 depending on the technology and/or the type or prior art that the user is interested in finding.

As the user accesses electronic patent documents, electronic publications, or other electronic information on the various web sites, reference information may be downloaded as the browser 103 accesses successive web pages. This is illustrated at step 550. At step 550, the user downloads an electronic document corresponding to accessing a web page containing an electronic version of a patent, electronic version of a published patent application, or electronic version of a publication or article.

When a user has identified an electronic document on a local network or on the internet containing reference information to be disclosed to a patent office, the user may signal IDS generation program 101 at step 560. The signal may be a mouse-click, pressing the enter key of a keyboard, or any other signal for indicating to a computer system on which IDS generation program 101 is running that a relevant document has been identified. Next, at step 570, IDS generation program extracts IDS information from the reference information in response to receiving the signal. Extraction of IDS information can be done by matching fields required for the IDS with appropriate information in the electronic document, which could be readily programmed by one skilled in the art. Finally, at step 580, the IDS generation program stores IDS information in an electronic IDS 102.

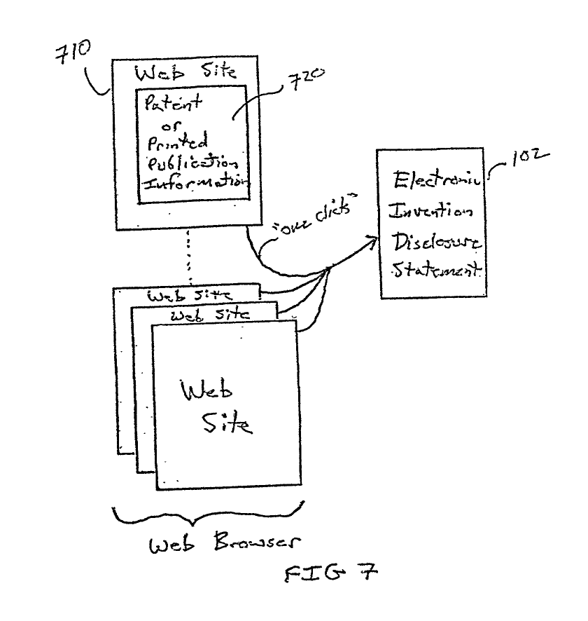

FIG. 6 illustrates another embodiment of the present invention that provides another technique for extracting the relevant information from a web page into an electronic IDS. According to the embodiment shown in FIG. 6, when a user locates an electronic document with relevant reference information to be disclosed to a patent office, patent web page 350 of FIG. 3B for example, the user may right-click the mouse to facilitate the extraction of the necessary information for the electronic IDS 102. As illustrated in FIG. 6, a standard right mouse click pop-up menu 610, which typically includes CUT 611, COPY 612, and PASTE 613, has been modified by IDS generation program to further include SAVE U.S. PATENT TO IDS 614, SAVE FOREIGN PATENT TO IDS 615, and SAVE PUBLICATION TO IDS 616. A user could then select the menu option corresponding to the type of document to be entered into the electronic IDS 102.

For example, if a user selects SAVE U.S. PATENT TO IDS 614, IDS generation program 101 will then prompt the user to identify the different pieces of information to be entered into the electronic IDS 102 that correspond to the required portions of U.S. Patent Document section 220 of IDS form 200. FIG. 6 illustrates that pop up menu 620 is provided to prompt user for each of the required pieces of information. The user then uses the mouse to select the portions of the patent web page 350 that correspond to each piece of required information. For example, the user may first select the patent number with the mouse and then click on the PATENT NO. 621 pop up menu option, and the IDS generation program can enter the selected patent number into the electronic IDS 102. Next, the user may select the issue date on the patent web page 350 with the mouse and then click on the ISSUE DATE 622 pop up menu option. The IDS generation program can then enter the selected issue date into the electronic IDS 102. Likewise, the user may sequentially select inventor name, the U.S. classification, sub-class, and filing date on patent web page 350, and the information will be entered into the electronic IDS 102 by correspondingly selecting INVENTOR 623, CLASS 624, SUB-CLASS 625, and FILING DATE 626.

On the other hand, if a user has located a foreign patent on a foreign patent web page (not shown), the user may select SAVE FOREIGN PATENT TO IDS 615. IDS generation program 101 will then prompt user to identify the different pieces of information to be entered into the electronic IDS 102 that correspond to the required portions of Foreign Patent Document section 230 of IDS form 200 of FIG. 2. FIG. 6 illustrates that pop up menu 630 is provided to prompt user for each of the required pieces of information. The information that must be extracted from a foreign patent is illustrated in FIG. 2 section 230 as the foreign patent number 231, foreign patent issue date 232, country 233, classification 234, sub-class 235, and translation (Y/N) 236. The user then uses the mouse to select the portions of the foreign patent web page (not shown) that correspond to each piece of required information. For example, the user may first select the foreign patent number with the mouse and then click on the PATENT NO. 631 pop up menu option, and the IDS generation program can enter the selected foreign patent number into the electronic IDS 102. Next, the user may select the foreign patent issue date on the foreign patent web page with the mouse and then click on the ISSUE DATE 632 pop up menu option. The IDS generation program can then enter the selected foreign patent issue date into the electronic IDS 102. Likewise, the user may sequentially select the country, the classification, and sub-class on foreign patent web page, and the information will be entered into the electronic IDS 102 by correspondingly selecting COUNTRY 633, CLASS 634, and SUB-CLASS 635. Finally, the user can indicate if a translation is available by selecting TRANSLATION 636 and YES, NO, or ABSTRACT. It should be noted that in some cases the foreign patent document may be a published patent application, in which case the ISSUE DATE 632 may be substituted for PUBLICATION DATE or just DATE.

If a user has located a relevant publication on a publication web page (not shown), the user selects SAVE PUBLICATION TO IDS 616. IDS generation program 101 will then prompt user to identify the different pieces of information to be entered into the electronic IDS 102 which correspond to the required portions of the section for publications and articles entitled Other Art 240 of IDS form 200 of FIG. 2. FIG. 6 illustrates that pop up menu 640 is provided to prompt user for each of the required pieces of information. The information that must be extracted from a publication is illustrated in FIG. 2 section 240 as the Name of Author 241, Title of Publication 242, Name of Publication 243, Pages 244, and Date of Publication (not shown). The user then uses the mouse to select the portions of the publication web page (not shown) that correspond to each piece of required information. For example, the user may first select the name of the author with the mouse and then click on the NAME OF AUTHOR 641 pop up menu option, and the IDS generation program can enter the selected name of the author into the electronic IDS 102. Next, the user may select the title of the article or publication on the publication page with the mouse and then click on the TITLE 642 pop up menu option. The IDS generation program can then enter the selected title into the electronic IDS 102. Likewise, the user may sequentially select the name of the magazine or publication, the relevant pages, and date of the publication, and the information will be entered into the electronic IDS 102 by correspondingly selecting NAME OF PUBLICATION 643, PAGES 644, and DATE OF PUBLICATION 626.

It should be noted that the embodiment of FIG. 6 is just one example of how an IDS generation program may extract the necessary IDS information from a electronic document having relevant reference information into an electronic IDS 102. Of course, other methods for extracting data from a web page could be utilized. In another embodiment, a user may click-and-drag one of the search results 300 of FIG. 3 into an electronic IDS. For that embodiment, an IDS generation program may include code for accessing an electronic document corresponding to each hypertext link associated with each patent result. For example, in response to clicking-and-dragging a particular search result hypertext link in search results page 300, the IDS generation program may automatically access the patent web page 350 for the selected patent. The IDS generation program may then automatically parse the reference information and download only the IDS information from the patent web page 350. The IDS information could then be automatically stored in an electronic IDS.

In another embodiment, when a user identifies a web site with a relevant document, the user may simply mouse click on an electronic button or menu option generated by the IDS generation program. In response to such a single mouse click, the IDS generation program may include code for automatically parsing the active web page and extracting the information necessary for completing the electronic IDS.

In yet another embodiment, the patent web pages 350 are divided into predetermined fields. Each field holds a particular predefined piece of information such as the title, patent number, or inventor name, for example. In such an embodiment, an IDS generation program automatically recognizes the fields and extracts the necessary IDS information by accessing each of the fields where the IDS information is located.

FIG. 7 illustrates accessing a first web site 710 and identifying an electronic document containing 720 patent or printed publication reference information that a user desires to disclose to a patent office. According to one embodiment, FIG. 7 illustrates that with just one click of the mouse the information necessary for completing the electronic IDS 102 is automatically extracted from the patent or printed publication reference information and entered into the electronic IDS 102. FIG. 7 also illustrates how multiple web sites can be accessed with the browser and how reference information from multiple electronic documents can be incorporated into the electronic IDS 102 with just a single mouse click for each electronic IDS entry. Therefore, embodiments of the present invention provide for a simplified method of generating invention disclosure statements. Accordingly, individuals under a duty of disclosure are more likely to comply with the disclosure requirements. This is in part because of the time is saved by utilizing embodiments of the present invention. A user is no longer required to obtain printed copies of every patent that must be filed in order to get the information necessary to fill out an IDS form 400. Moreover, the time and resource consumption associated with manually filling out an IDS form 400 is eliminated. Additionally, the potential liability for accidentally failing to include a reference while preparing an IDS form 400 is also eliminated.

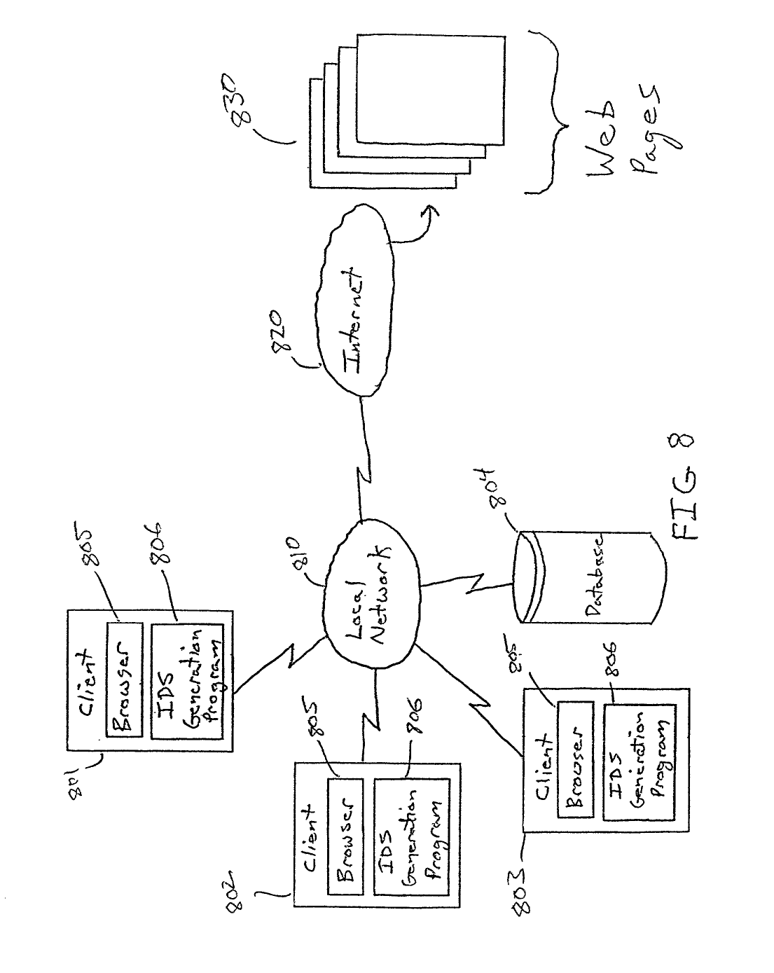

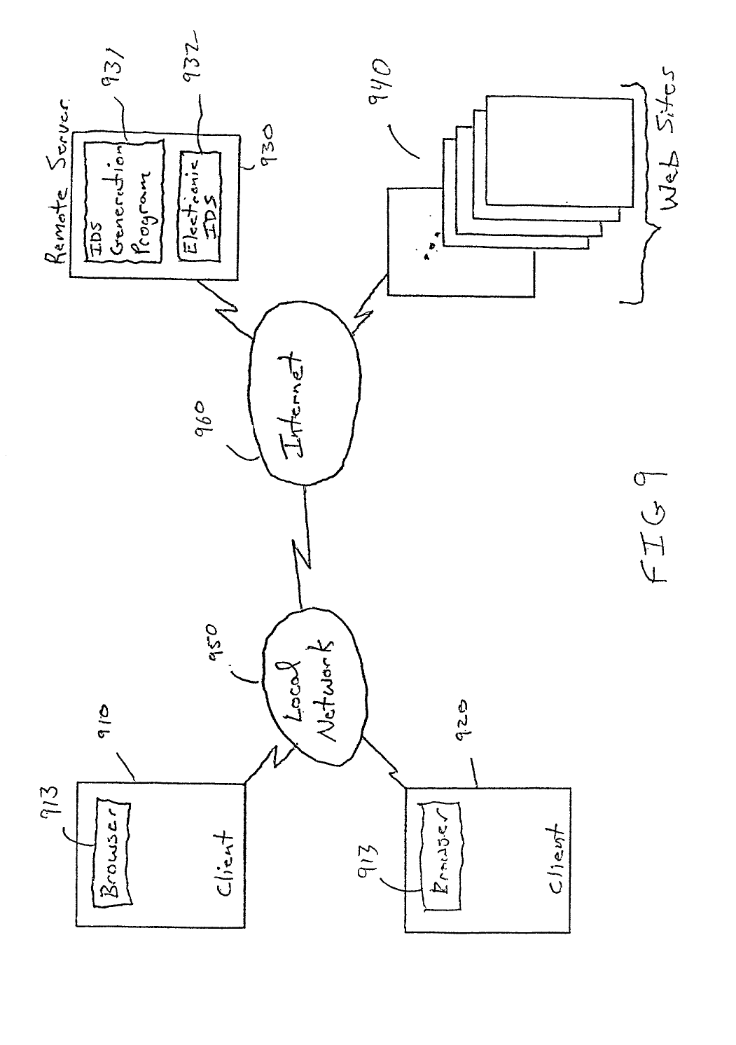

FIG. 8 is a simplified diagram of an example of a hardware system according to another embodiment of the present invention. FIG. 8 shows a group of client systems 801, 802, and 803 that are connected together and to a local database 804 by a local network 810. Database 804 may store multiple electronic IDS corresponding to multiple inventions, for example. The local network is connected to the internet 820 for accessing remote web sites 830. FIG. 8 illustrates that in another embodiment of the present invention the IDS generation program 805 may reside on multiple clients 801-804. Therefore, according to the embodiment of FIG. 8, multiple client systems 801, 802, and 803 could each access an electronic IDS stored in database 804. For example, client systems 801-804 may each include a local browser 805 and IDS generation program 806 for accessing web pages on the internet and storing IDS information into an electronic IDS stored in database 804.

Additionally, each client system would be able to access all of the electronic IDS stored in database 804. This embodiment is particularly suited for applications where multiple users will be generating and accessing the same electronic IDS for a single pending or future patent application.

As mentioned earlier, one embodiment of IDS generation program 806 may include program code for controlling the user access rights for each electronic IDS. Such code may require the user to enter an access code or password before being allowed access to an existing electronic IDS. For example, the access to each electronic IDS may be limited to individuals falling under the duty of disclosure for the corresponding future or pending patent application. Therefore, an IDS generation program may prompt a user for an access code when a user requests access to an electronic IDS. If the user provides the correct code, then the IDS generation program may allow the user to access the electronic IDS. However, if the user provides an incorrect code, the IDS generation program may not allow the user to access the electronic IDS. This feature would be particularly useful for ensuring that only individuals associated with the filing and prosecution of a particular patent application will have the ability to update or modify an electronic IDS corresponding to a particular patent application.

FIG. 9 is a simplified diagram of an example of a hardware system according to another embodiment of the present invention. FIG. 9 includes client systems 910 and 920 connected together over a local network 950 and to a remote server 930 over internet 960. Client systems 910 and 920 each includes a browser 913 that can be used to access the remote server 930 web site. The IDS generation program 931 can then be accessed allowing a user to remotely generate and modify new or existing electronic IDS 932. One advantage of this embodiment is that multiple users may search web sites 940 over the internet 960 for electronic documents that can be incorporated into the electronic IDS 932.

The embodiment of FIG. 9 utilizing a remote server 930 is particularly useful for applications where users in multiple locations need to access and generate the same electronic IDS 932. For example, this embodiment would be useful when an inventor generates a new electronic IDS 932 on remote server 930 at the beginning of the patent process. Later, an in-house attorney located at another location (e.g. corporate headquarters) may access and contribute to the electronic IDS 932. Then, even later in the patent process, an outside attorney in yet another location (e.g. a law firm) may access and contribute to the electronic IDS 932, for example.

FIG. 10 is a simplified diagram of an example of a hardware system according to another embodiment of the present invention. The embodiment of FIG. 10 includes a first local network 1010 having multiple client systems 1011, 1012, and 1013. Client systems 1011-1013 may access an intellectual property (“IP”) service provider web site 1040 through the local network 1010 and internet 1030. A second local network 1020 also having multiple clients 1021, 1022, and 1023 provides access to the IP service provider 1040 through internet 1030.

IP service provider web site 1040 includes a database 1041, an IDS generation program 1042, and a search engine 1043. IP service provider may be a web site that allows customers to manage and manipulate intellectual property information remotely. For example, in one embodiment, customers of an IP service provider may be allowed to remotely access search engine 1043. A user may access search engine 1043 for the purpose of conducting research into a particular field of technology. Using search engine 1043, a user may access electronic versions of technical documents stored in database 1041. Alternatively, a user might access electronic versions of technical documents located at web sites 1050 or 1060 in databases 1051 or 1061 respectively. In one embodiment, IDS generation program 1042 is running in the background, and when the user discovers an electronic document that is relevant to a future or pending patent application, the user may signal the IDS generation program to enter the document in an electronic IDS.

In another embodiment, IDS generation program 1042 on IP service provider web site 1040 may provide a user with information on when it is necessary to file an IDS. For example, if a user is conducting research using search engine 1043 and discovers a document that may be relevant, the user can signal IDS generation program to provide instructions on when it is necessary to file an IDS. IDS generation program 1042 may provide a help window with text illustrating the rules for filing an IDS. Alternatively, IDS generation program 1042 may provide the user with a series of questions designed to guide the user through the process of determining if the particular document must be disclosed to a patent office. Ultimately, the IDS generation program may provide the user with a menu selection or electronic button allows the user to signal the IDS program to extract IDS information from the document and store the IDS information in an electronic IDS.

In yet another embodiment, the first local network corresponds to a corporate client of the IP service provider web site 1042 and the second local network to a law firm. The law firm may prepare and a patent application for the corporate client and use the services of the IP service provider to file the patent application. In that case, when the patent application is filed, either manually or electronically, a signal is sent to IDS generation program 1042 indicating that an IDS is to be submitted. In response to the signal, IDS generation program may automatically retrieve an electronic IDS from database 1041 and file the electronic IDS with the patent application. In another embodiment, the IDS generation program automatically searches the database 1041, first local network 1010, and second local network 1020 for any electronic IDS associated with the patent application to be file. The IDS generation program may then cause multiple electronic IDS from multiple locations to be filed in the patent office with the patent application.

In another embodiment of the present invention, the IDS generation program includes additional code for automatically generating a letter to third parties in other countries when an IDS is filed in one country. For example, if an electronic IDS is filed in the USPTO at the time of filing a patent application on a particular invention, IDS generation program may generate a letter to lawyers in other countries where the invention is to be filed to inform them of what references were cited in the USPTO patent case. Alternatively, the IDS generation program may generate an email indicating that an IDS has been submitted and what references were in the IDS. For example, in one embodiment, the IDS generation program may generate an email to the U.S. lawyer indicating that an IDS has been submitted in another non-U.S. case and indicate the references cited in the case. The IDS generation program may then allow the user to select any or all of such references to be saved to an electronic IDS for the U.S. or non-U.S. case, as appropriate. The IDS generation program preferably performs an automatic check of any references already cited in electronic IDS documents in the case and notifies the user to allow deletion of any duplicates. The IDS program may also be written to identify a foreign patent office search report received or uploaded electronically in connection with a particular case and notify the user of such receipt. The program may then automatically check any electronic IDS documents for the corresponding U.S. case and notify the user of any references not yet cited. The user may then select any such references to be included in a new electronic IDS for the U.S. case in the manner described above.

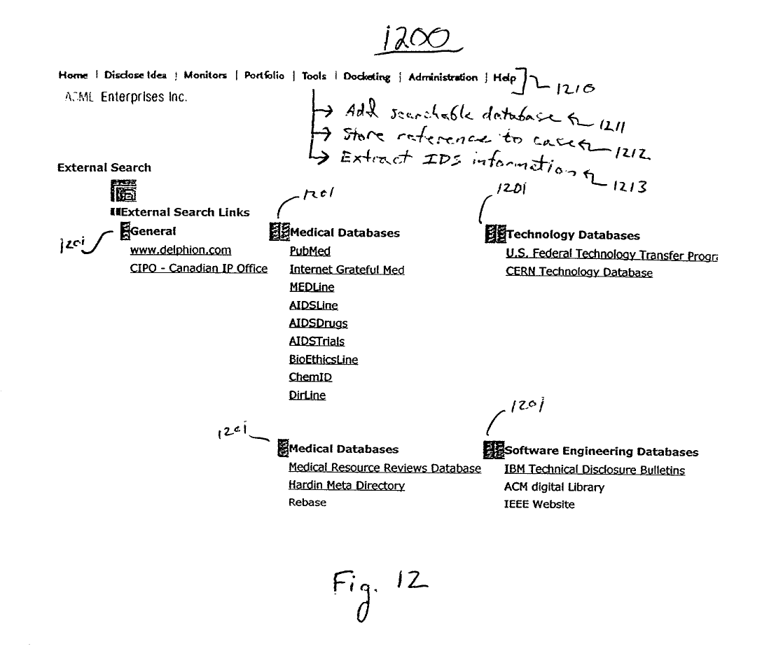

FIG. 11 is a simplified block diagram showing the relationship between an intellectual property (IP) data processing system 1100 according to one embodiment of the present invention and participants in the patent process. The participants shown in FIG. 11 include technology developers 1110, patent law firms 1120, service providers 1130, official patent offices 1140, prior art databases 1170 and potential licensees 1160. As described in detail below, IP data processing system 1100 is a Web-enabled electronic platform that can be utilized by all participants in the patent process. Processing system 1100 converts the paper-based patent prosecution system into an electronic workflow pipeline, allowing every step in the process to be executed from a computer desktop, slashing administrative costs and processing time for patent applications.

Processing system 1100 provides technology developers 1110 and their associated patent law firms 1120 a highly secure, central data repository that can be shared between participants on an as-allowed basis. Information generated and used during the patent prosecution process can be shared between a technology developer 1110 and appropriate patent law firm 1120 and service providers 1130 in order to create patent filings, prosecute such filings through issuance and then subsequently maintain patents after grant.

Some specific functions provided by IP data processing system 1100 include:

online creation of invention disclosures, witnessing, archiving and secure sharing of invention disclosures between technology developers and patent counsel;

automated conversion of invention disclosures into patent applications and instant electronic filing of such applications in the PTO, giving inventions the earliest possible filing dates;

electronic filing and prosecution of patent applications in patent and offices worldwide, allowing all correspondence to and from patent offices to be paperless;

automated docketing in a standardized database accessible to all authorized participants, electronic notification of due dates and electronic payment of annuity fees;

IP portfolio visibility, on-demand status reporting, and strategic IP analysis, extending not only to issued patents, but to invention disclosures and pending applications as well;

data mining of IP portfolios and targeting of potential licensees;

online receipt and examination of patent applications and issuance of office actions by patent offices worldwide;

coordinating, tracking and providing payment options for all financial aspects of the patent process including patent office fees, attorney fees and service provider fees.

As mentioned above, in addition to IP data processing system 1100, FIG. 11 shows various patent process participants including technology developers 1110, law firms 1120, service providers 1130, official patent offices 1140, prior art databases 1170 and licensees 1160 connected to IP data processing system 1100 through the Internet 1150. For convenience, each of these participants is referenced by a dotted line that encompasses individual entities of the participant type. For example, technology developers 1110 are shown in FIG. 11 as including individual technology developers 1110(1), 1110(2) through 1110(n). It is to be understood that, while shown in FIG. 11 as a group, these multiple technology developers are separate entities that likely have no relation to each other than their classification within this patent application as developers of technology. It is also to be understood that, while not shown, each individual participant systems typically includes its own firewall system that implements access control functions to isolate the system from unwanted intrusions by others.

Technology developers 1110 include corporations, universities and individual inventors seeking to file patent applications and receive issued patents. Patent law firms 1120 include U.S. patent attorneys, patent agents and foreign patent attorneys and/or agents. Service providers 1130 include patent draftsman, prior art search companies, translation companies and other entities that provide services useful to the patent process as well as financial institutions and other parties that have tangential roles in the process. Prior art databases 1170 include public and licensed private databases, such as online patent databases (e.g., issued U.S. patents, published European and Japanese patents, etc.) and non-patent databases. Patent offices 1140 include official patent offices worldwide including the USPTO, the European Patent Office (EPO), the Japanese Patent Office (JPO), the Taiwanese Patent Office, etc.

As shown in FIG. 11, IP data processing system 1100 includes a Web server 1101, a database 1106 and paper mailroom 1108. Web server 1101 includes a server engine 1102 that generates and sends graphical documents including Web pages 1104$to client systems as requested and an electronic mailroom 1107. As used herein, a “client system” is a computer system that displays Web pages generated by server engine 1102, e.g., through a browser residing on the client system. Thus, technology developers 1110, patent law firms 1120, service providers 1130 and licensees 1160 typically include one or more client systems. For example, a large corporation (technology developer) may have 150 inventors, 4 patent administrators and 2 in-house patent attorneys. Each of these individuals likely has their own computer system and can thus become a client system. Additionally, computers that are part of official patent offices 1140 can also be client systems in some embodiments of the invention.

Each client system can display the Web pages generated by server engine 1102. Each of such Web pages is uniquely identifiable by a Uniform Resource Locator (URL) and is stored in a computer-readable memory (not shown) accessible to the server engine. To view a specific document, including a Web page, a client system uses a Web browser executing on the client system to specify the URL for the document in a request (e.g., a HyperText Transfer Protocol “HTTP” request) as is known to those of skill in the art. The request is forwarded to the Web server supporting the document (server system 1101 in this instance), which when it receives the request, sends the requested document to the client system. The Web browser may then display a Web page contained in the document, e.g., HTML document.

Database 1106 stores all information pertaining to the patent developers' intellectual property portfolios. Patent process participants (such as the technology developer employees and outside law firm personnel) access this information as needed and only to extent that their access rights permit. The information in database 1106 includes draft and completed invention disclosures, draft and completed patent application documents, messages and discussions pertaining to invention disclosures and patent applications, patent and patent application status information, prior art publications, etc. A more complete list of some of the data types stored within database 1106 and the attributes of that data is shown in the Appendix at the end of this application.

IP data processing system 1100 communicates with official patent offices 1140 over internet 1150 through electronic mailroom 1107 and through standard snail mail (e.g., U.S. Postal Office Express Mail) using paper mailroom 1108. For such communications, system 1100 sets the correspondence address to mailroom 1107 or 1108 so that replies to the communications can be tracked and entered into database 1106 as described below.

Electronic mailroom 1107 is part of server 1102 and includes a suite of programs that interface to the standards set by each official patent office 1140. For example, in order to file patent applications electronically through the USPTO the system comports to the standards required by the USPTO's Electronic Filing System (EFS). This includes using the Electronic Packaging and Validation Engine (ePAVE) or compatible software to facilitate electronic filing. Complete details of the ePAVE software are available online through the USPTO's Electronic Business Center Web site at http://pto-ebc.uspto.gov/. Also, in order to track and update status information for pending patent applications, such as Examiner name, assigned art unit and class/subclass, etc., electronic mailroom 1107 has the ability to interface to USPTO's Patent Application Information Retrieval (PAIR) system using appropriate digital certificates. Electronic mailroom 1107 also includes other programs to interface with other official patent offices.

Paper mailroom 1108 includes printers, fax machines and other appropriate equipment to carry out all the duties necessary to file patent applications and other formal papers in official patent offices using standard mailing procedures. Paper mailroom 1108 also includes scanners and equipment necessary to scan papers received from technology developers 1110, patent attorneys 1120 and patent offices 1140 into computer-readable format. Such correspondence is scanned and analyzed by optical character recognition (OCR) software to create two version of the document: an image version and a text version created by the OCR software. The OCR software is calibrated to recognize particular fields within common Patent Office forms to capture data from those forms so that appropriate data (e.g., due dates, Examiner's name, Applicant, application no., etc.) from such papers can be parsed and entered into database 1106. To this end, the fields of various Patent Office forms that are scanned by mailroom 1108 are mapped to database 1106 along with the document type (determined from the form recognition sequence) in order to enable the system to determine the appropriate docketing deadlines. Alternatively, or in addition to such scanning, personnel in mailroom 1108 can directly enter appropriate data into database 1 106 using computers or data entry terminals coupled to the database through a local area network or similar network. Once scanned into computer-readable format, communication between IP data processing system 1100 and technology developers 1110 can proceed in a manner that, from the standpoint of a technology developer, seems entirely paperless.

IP data processing system 1 100 also provides a conduit through which users of the system may generate, manage, and process information disclosure statements. According to one embodiment of the present invention, an IDS generation and management program having a subset or superset of the IDS generation program described above is integrated into the an IP data processing system having a subset or superset of the features included in IP data processing system 1100 of FIG. 11.

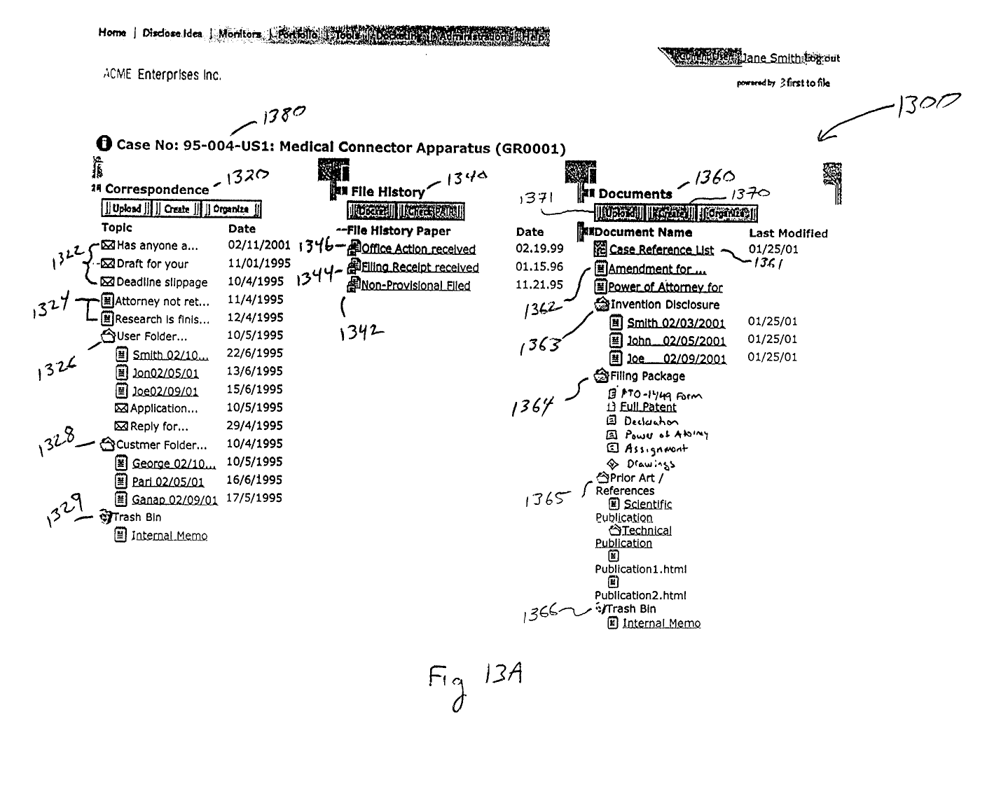

For example, in one embodiment, the IP data processing system 1100 may include a search feature as shown in FIG. 12. FIG. 12 illustrates a search web page 1200 that may be accessed by a user of IP data processing system 1100 for search external web sites for reference documents which may include information to be submitted in an IDS according to one embodiment of the present invention. Search web page 1200 may include categorizations 1201 of external search engines to aid the user in finding relevant references. For example, search web page 1200 includes search engines categorized as “General,” for sites have all types of references, “Medical Databases,” for references particularly relevant to medical inventions, and “Software Engineering Databases,” for references particularly relevant to software inventions. Of course, other categorizations for other technologies could be used. Each category 1201 includes a list of hyperlinks (“link”) to one or more databases containing information in the particular category. For example, the “General” category includes a link to the web site for “ww.delphion.com,” which is a currently well know web site known to include a searchable database of issued patents and published patent applications. Other patent or publication databases could also be included by adding a link to the search web page 1200 using an “add searchable database” menu option 1211 in toolbar 1210. In one embodiment, when a relevant reference is found by a user, the user may associate the reference with an electronic IDS by mouse clicking the “store reference to case” menu option 1212 in the toolbar 1210. Accordingly, the reference may be downloaded and stored in association with the particular case, and the electronic IDS may be generated at a later time. In one embodiment, the user may associate the reference with an electronic IDS by mouse clicking the “Extract IDS information” menu option 1213 in toolbar 1210. Accordingly, the IDS information may be automatically extracted from the reference and associated with an electronic IDS for one or more cases.

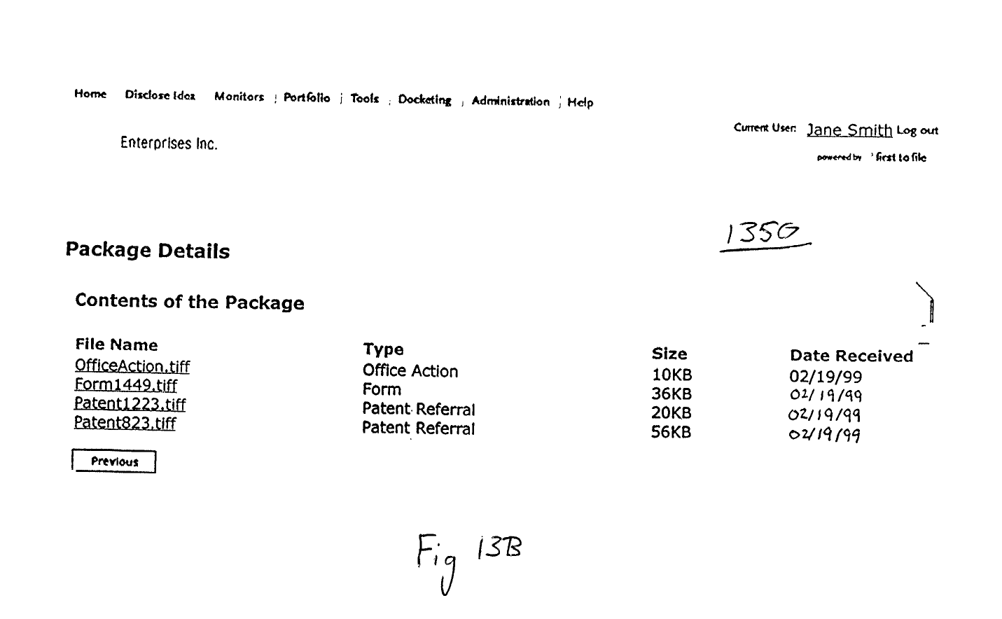

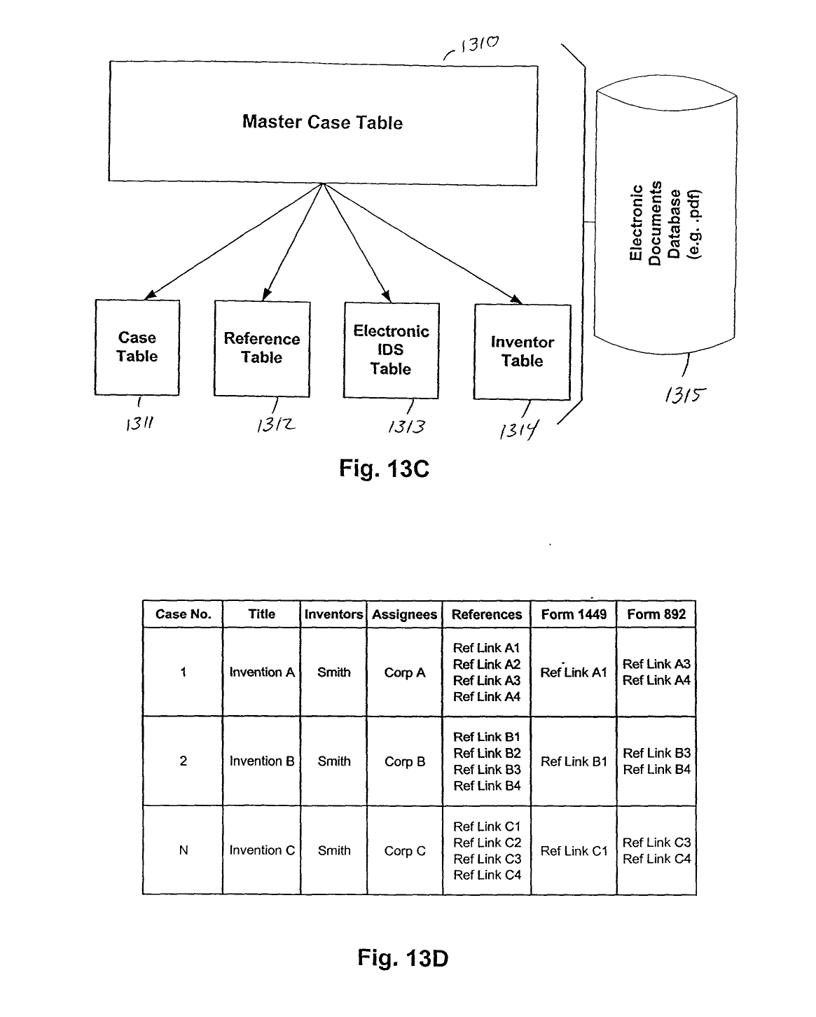

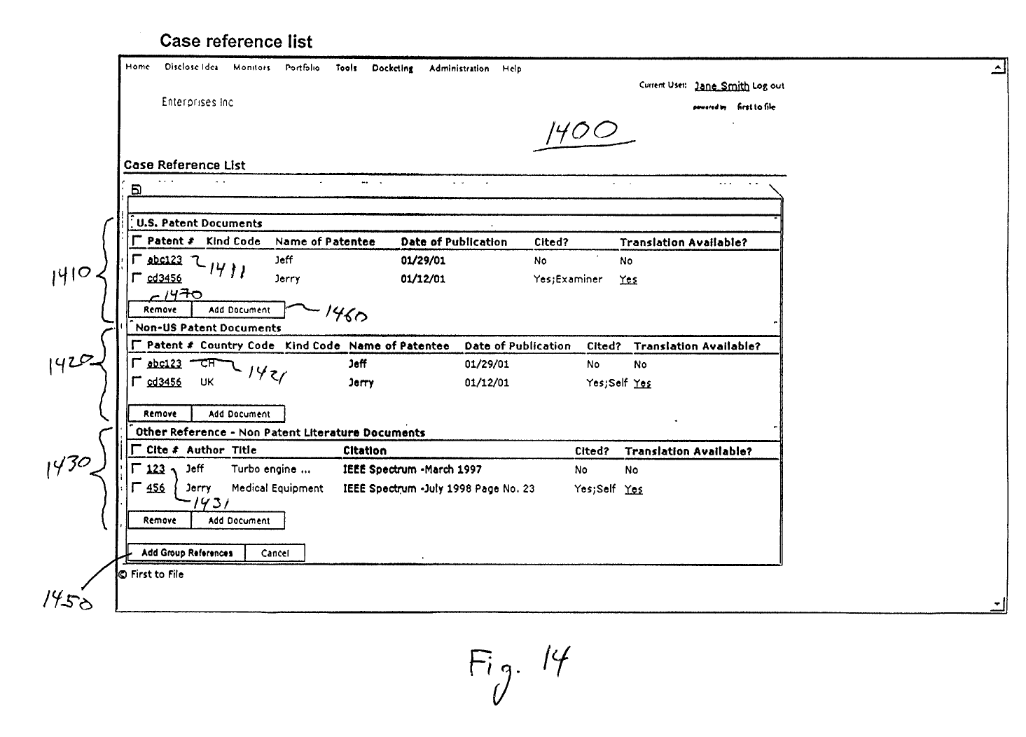

In one embodiment of the present invention, each patent application case on the IP data processing system 1100 will have a plurality of information associated with the case stored in a database and accessible by a user through a “trifold” user interface. The graphical user interfaces employed by embodiments of the present invention are described in more detail in commonly owned U.S. Application No. Unassigned, filed Jul. X, 2001, entitled “USER INTERFACE FOR MANAGING INTELLECTUAL PROPERTY,” and listing Jeffrey J. Grainger as inventor, the disclosure of which is hereby incorporated herein by reference in its entirety. FIG. 13A shows an exemplary Web page 1300 according to one embodiment of a trifold graphical user interface that provides a client system access to communications and documents, such as relevant references and electronic IDS's, associated with the patent application.

As shown in FIG. 13, Web page 1300 includes correspondence section 1320, file history section 1340, document section 1360, and information section 1380. Correspondence section 1320 includes several email messages 1322 and documents 1324, e.g., MS Word files. It also includes folders 1326 and 1328 with each folder including additional documents. If desired, folders 1326 and 1328 can be created by a client system to organize and save documents, email messages, etc. that are related to a specific subject or issue that are pertinent only to certain client systems and thus are not viewable by others. Section 232 also includes a trash bin 1329 that stores deleted documents and messages until they are purged.

File history section 1340 includes a patent application 1342 and its associated documents that were filed in a patent office as well as a filing receipt 1344 and first Office Action 1346 that were received from the patent office. Each of the links 1342, 1344, and 1346 actually represents a package of several documents with each individual document being stored in an image file format. For example, an electronic IDS according to the present invention may be included as one of the documents in a package received from or transmitted to a patent office. Upon selecting the link, a Web page is displayed that shows the contents of the package and allows viewing access to the underlying documents. In this example, patent application package 1342 was generated through IP data processing system 1100 and filed electronically. Upon filing the application, an archived copy of each of the filed papers was created electronically in .pdf format and saved in section 1340. Packages 1344 and 1346, on the other hand, were received at paper mailroom 1108 and scanned into .pdf format. Once these documents were associated with case number 95-004-US 1 links to the documents were automatically created for display in section 1340. The lock displayed next to each of packages 1342, 1344, and 1346 indicates that the documents contained in these packages are locked and therefore cannot be edited.

FIG. 13B is an example of a Web page 1350 that shows the contents of office action package 1346. As shown in FIG. 13B, package 1346 includes four different documents each stored in an image file format: a copy of the Office Action itself, a electronic IDS formatted to correspond to a PTO-1449 form, and electronic copies of two different patent reference documents that are referred to in the Office Action.

The document section 1360 contains a “Case Reference List” link 1361. A user may obtain information about what references have be associated with a particular patent application by mouse clicking the “Case Reference List.” Document section 1360 also includes an amendment 1362 that is being prepared in response to the Office Action associated with link 1346, a folder 1363 that contains copies of several different versions of original invention disclosures for the patent application prepared by different inventors, and a filing package folder 1364 that contains documents filed in the patent office with the patent application. At least some of the documents in folder 1363 correspond directly to the documents in patent application package 1342. For example, as described above, if patent application package 1342 includes the patent specification, the patent drawings, separate inventor oath and declaration forms, a power of attorney form, an assignment form, an electronic invention disclosure statement, and a transmittal form - each in an image file format, filing package folder 1364 contains copies of these documents in their underlying native application format. That is, folder 1364 contains a copy of the patent application in word processor format, an electronic IDS corresponding to a PTO-1449 form, separate declaration and power of attorney forms, an assignment form, and patent drawings in either a format associated with a drawing program or a scanned format. Corresponding pairs of documents for responses to office actions and other papers created through system 1100 and filed in a patent office will also exist between section 1340 and 1360 in other instances.

Section 1360 also includes a prior art folder 1365 that holds links to various prior art electronic documents, e.g., the documents cited in the electronic IDS. Prior art folder 1365 includes links to electronic versions of scientific materials and technical publications. Prior art folder 1365 may also include links to patents. Finally, section 1360 also includes a trash bin 1366 that is similar to bin 1329.

FIG. 13C illustrates how data in the database may be organized in tables according to one embodiment of the present invention. A master case table 1310 may be used to define fields in the trifold and link to other tables holding other data. For example, the master case table may link to a case table 1311 including case numbers, a reference table 1312 including links to all electronic reference documents associated with a case, an electronic IDS table 1313 including links to electronic reference documents cited in the electronic IDS (e.g., an electronic version of form 1449 or 892), and an inventor table 1314 including names of inventors. Of course, it is to be understood that additional tables are also provided to store other data. The above description is for illustrative purposes only.

FIG. 13D illustrates how data in different tables may be related. A master case table 1310 may include fields for case number (e.g., “Case No.”), title, inventors, assignees, references, form 1449, and form 892, as well as other fields for other elements included in the trifold. A first case number “1” may occupy a first location in the case number table. The other fields are presented as columns to illustrate the relation of a case number to other data in other tables. As shown in FIG. 13D, a title table may contain a list of patent application titles, an inventor table may contain a list of inventors, and an assignee table may contain a list of assignees. Furthermore, a reference table may contain a list of reference links to the electronic documents stored in the database 1315. Additionally, cited reference tables may be included, such as form 1449 table and form 892 table, for storing cited reference links to electronic documents that have been cited to a patent office.

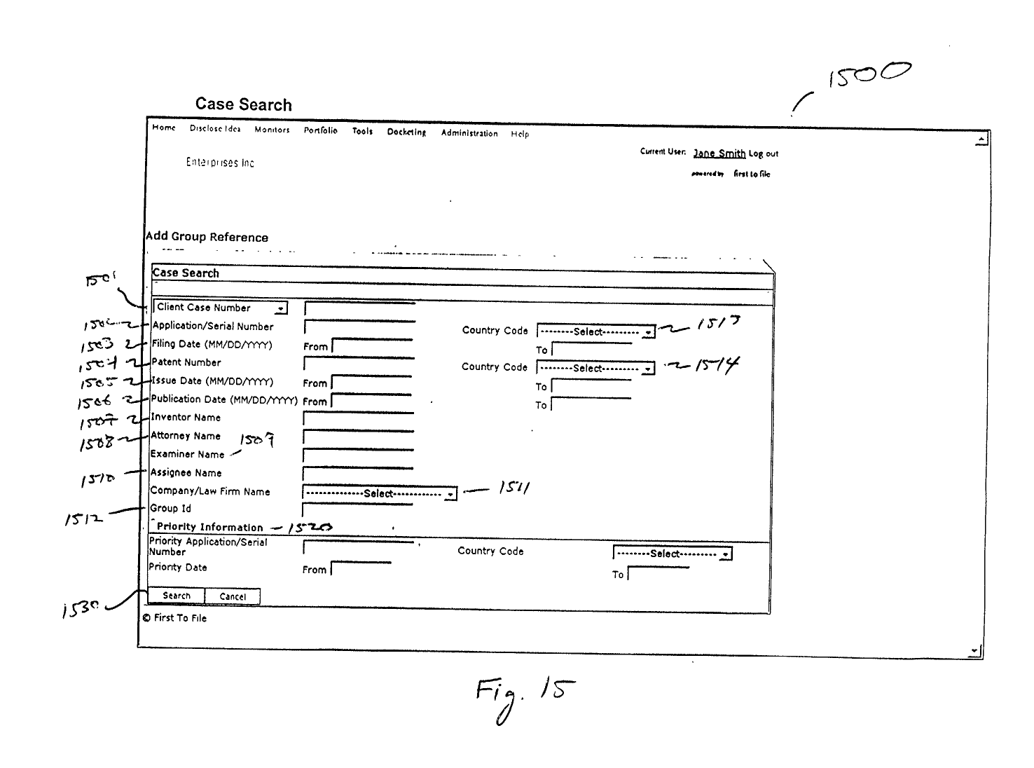

Thus, case number 1, in the first row, would be associated with the title “invention A,” inventor “Smith,” and assignee “Corp A.” Case number 1 would also be associated with multiple electronic documents through links Ref Link A1, linking to electronic document A1 in the database 1315, Ref Link A2, linking to electronic document A2, Ref Link A3, linking to electronic document A3, and Ref Link A4, linking to electronic document A4. Case number 1 may at some previous time have had an information disclosure statement submitted to the patent office. Thus, case number 1 would be associated with the electronic reference document Ref Link A1 in “Form 1449” cited reference table. Additionally, case number 1 may also have received cited references from the patent office. Thus, case number 1 would be associated with links Ref Link A3 and Ref Link A4 in “Form 892” cited reference table. It is to be understood that the cited reference links in the cited reference tables may not always be the same as the reference links in the reference table. This is because additional electronic reference documents may have been loaded into the database and associated with a case, but not yet cited to the patent office. Additionally, the reference links in the reference table may not always be the same as the cited reference links in the “Form 892” cited reference table because the patent office may have discovered an additional prior art document, an electronic version of which has not yet been loaded into the database. Furthermore, it is to be understood that data in the database 1315 may be stored and manipulated by relational database programming techniques, non-relational database programming techniques, or object oriented database programming techniques. Additionally, multiple case numbers may link to a single electronic reference document in the database, which may be stored as only one link in the reference table. Thus, a single electronic document in database 1315 may be associated with one or more patent cases in the IP data processing system. Accordingly, the above description is merely illustrative. “Case Reference List” link 1361 is a link to a Web page, such as page 1400 shown in FIG. 14. When entering Case Reference Web page 1400 from the trifold for Case No. 95-004-US1, the Case Reference Web page 1400 displays all the electronic documents, e.g., patents and other reference documents that are believed to be material to the patent application, associated with Case No. 95-004-US1. Accordingly, the patents and other references listed on Case Reference Web page 1400 may used to generate an electronic IDS. A user of IP data processing system 1100 can maintain this list during the lifetime of the case by adding references to the list and periodically generating an electronic IDS. The electronic reference documents contained in the list feed the electronic IDS forms, when such forms are created, in accordance with whether or not the reference documents have been previously cited to the patent office.

Case Reference Web page 1400 displays links and information for references associated with the case in three sections: U.S. Patent Documents 1410, Non-US Patent Documents 1420, and Other References 1430 for non-patent disclosures such as technical publications, articles, or Web sites containing relevant materials. Each section may include one or more links to the underlying electronic documents such as, for example, link 1411 linking to a electronic U.S. patent document (e.g. issued patent or published application), link 1421 linking to an electronic foreign patent document, and link 1431 linking to an electronic non-patent disclosure. Furthermore, each row, corresponding to a particular reference, includes a number of columns that each display relevant information corresponding to the reference. For example, the row for link 1411, in addition to displaying the link to U.S. Patent “abc123” in the first column designated “patent number,” may also include additional columns for displaying information such as patentee name, publication date, whether or not “abc23” Patent has been cited to the patent office (e.g., “Cited?”), and the availability of a translation. Similarly, the row for link 1421, in addition to displaying the link to Foreign Patent “abc123” in the first column designated “patent number,” may also include additional columns for displaying information such as country code, patentee name, publication date, whether or not “abc123” Patent has been cited to the patent office, and the availability of a translation. It is to be understood that, although links 1411 and 1421 both indicate “abc 123,” in an actual application the links would point to different electronic documents. The designation “abc123” in FIG. 14 is for illustrative purposes only. In a similar manner, information about “other art” may be displayed across the columns of section 1430. Thus, the row for link 1431, in addition to displaying the link to electronic document “123” in the first column designated “cite number,” may also include additional columns for displaying information such as author, title, citation, whether or not the “123” reference has been cited to the patent office, and the availability of a translation.

One feature provided in some embodiments of the present invention is that whenever an action is taken to create a document from the trifold user interface, IP data processing system automatically associates the created document with the patent application file shown on the trifold interface. For example, referring back to FIG. 13A, document section 1360 includes create and upload icons (i.e., prompts such as electronic buttons) 1370 and 1371. Selecting upload button 1371 allows a client system to upload a document that was not originally created through IP data processing system 1100 into the system. When the upload button is selected from page 1300, the uploaded document is automatically associated, e.g., in a database table, with Case No: 95-004-US1 that trifold interface 1300 provides access to. Similarly, create button 1370 allows the client system to initiate creation of a new document, such as a electronic IDS. When create button 1370 is selected, all fields for the new document that can be populated with data that is already in database 1106 are so populated as described in more detail below, and the document is automatically associated with the case displayed in the user interface. The system may prompt the user for specific information for unpopulated fields or confirmation (and validation) of populated fields.

Thus, according to one embodiment of the present invention, the upload button 1371 may be mouse clicked by a user. In response to mouse clicking the upload button 1371, a load signal is transmitted from the user's client system to the IP data processing server. An electronic document, such as a electronic version of a United States Patent, foreign patent, or publication, may then be loaded from an external database to the IP data processing server database. As described above, the loaded electronic document will be associated with the patent case corresponding to the currently active trifold. For example, a reference link could be stored in a reference table and associated with the active case number, as described above. Additionally, the electronic document could also be associated with other cases as well. Furthermore, a user could similarly load additional electronic documents, and associate them with particular cases, by repeating the process.

Once the user has loaded and associated the electronic reference documents with a case, the user may mouse click the create button 1370 to transmit a create electronic IDS signal from the client system to the server system. Of course, it is to be understood that the create button could correspond directly to creation of an electronic IDS, or alternatively, may generate a menu of create options that includes creating an electronic IDS. Additionally, other equivalent nomenclature for “create” and “upload” could be used to prompt a user. In response to receiving the create signal, the IP data processing system server may automatically generate an electronic information disclosure statement. In one embodiment, the server may access some or all the electronic documents associated with the case, and extract the IDS information from each associated electronic document. Of course, the IDS information may be extracted automatically from the references according to a variety of techniques, or alternatively, a data entry menu could be provided to allow the user to manually enter the information for each reference. Manual entry could be done at the time of creation of the electronic IDS or at an earlier time, such as when the electronic reference document is loaded into the system database. In one embodiment, the electronic documents may be stored as image files. Thus, character recognition algorithms may be utilized to extract the IDS information from the documents. In another embodiment, each electronic document includes a plurality of fields for storing the IDS information. Thus, when a new electronic IDS is created, the server could go in and extract the IDS information from the fields in the electronic documents. The IDS information for each reference may then be entered into an electronic version of an information disclosure statement.

According to another embodiment, when an electronic IDS is created, the server system compares the reference links in the reference table to the cited reference links in the cited reference table. The server only processes document links in the reference table that are not in the cited reference table. Thus, only IDS information from uncited electronic documents will be associated with the electronic IDS. In other words, even though the reference table may hold all the electronic reference documents associated with the case, some of the documents may already have been cited, thus making submission of such documents unnecessary. Accordingly, the server will not include documents from the reference list in the electronic IDS that have already been cited.

Referring again to FIG. 14, Case Reference Web page 1400 also includes an Add Group Reference button 1450 to initiate cross referencing of electronic reference documents between cases according to another embodiment of the present invention. The cross referencing feature allows a user to access related cases to examine the electronic reference documents associated with the other cases. Related cases may include, for example, other cases with one or more common inventors, cases having the same assignee, and parent cases having related continuations, divisionals, or continuation-in-part cases. If one or more of the electronic documents associated to a related case are relevant to the active case (i.e., should be submitted to the patent office), the user may associate such documents with the active case. Thus, by activating the cross referencing feature, the user may access related cases, display the electronic reference documents associated with such related cases, and select one or more of the electronic reference documents associated with the related case to be associated with the active case.

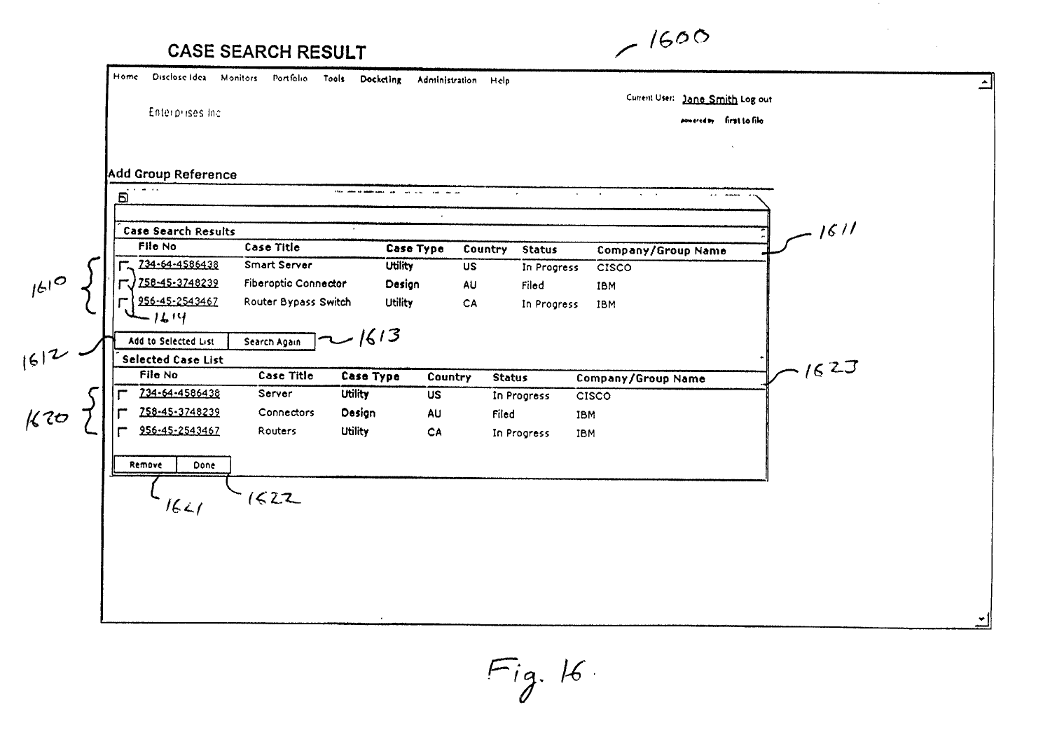

FIG. 15 illustrates a case search Web page 1500 activated in response to mouse clicking the Add Group Reference button 1450 according to one embodiment of the present invention. According to one embodiment, the first step in cross referencing related cases may optionally be to search for related cases using case search page 1500. Case search page 1500 includes a number of criteria upon which a search can be performed. For example, a user could search by client case number 1501, application serial number 1502 and country code 1513, filing date range 1503, patent number 1504 and country code 1514, issue date range 1505, publication date range 1506, inventor name 1507, attorney name 1508, examiner name 1509, assignee name 1510, company or law firm name 1511, or a group ID 1512. Additionally, a user may search using priority information 1520. A search button 1530 is provided to activate the search.

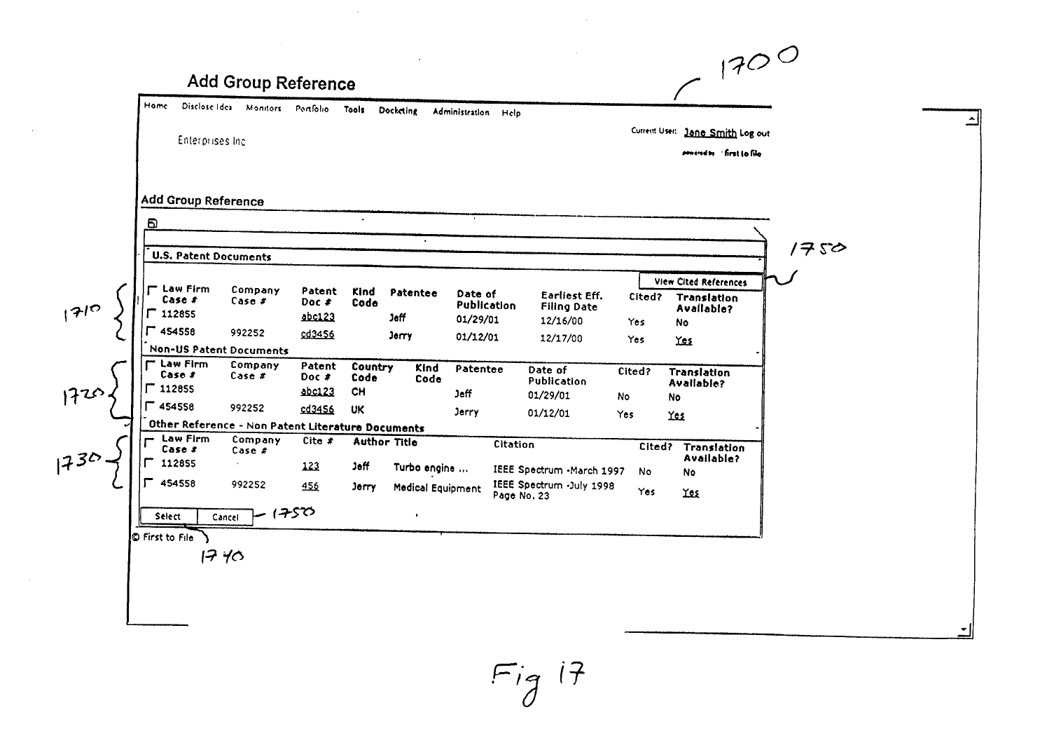

FIG. 16 illustrates a case search result Web page 1600 used to provide the results of the search carried out in case search page 1500 according to one embodiment of the present invention. Case result search page 1600 can be used to display the results of one or more searches. A case search result field 1610 displays a list of cases returned as a result of the search (e.g., file numbers). Additional information may be displayed about the case, as shown by display line 1611, such as, for example, the title, case type (e.g., U.S. or foreign), case status, and company or group name. A user may select one or more of the cases for cross referencing by mouse clicking select boxes 1614 and “Add to Selected List” button 1612. Selected cases are added to the selected case list 1620. As with the case search result field 1610, additional information may be displayed in the selected cases list 1620, as shown by display line 1623, such as, for example, the title, case type (e.g., U.S. or foreign), case status, and company or group name. Additional searches may be conducted by mouse clicking the “Search Again” button 1613. After one or more searches have been completed, and one or more related cases have been identified, a user may end the process by mouse clicking the “Done” button 1622. Alternatively, mouse clicking the “Remove” button 1621 may remove selected cases.

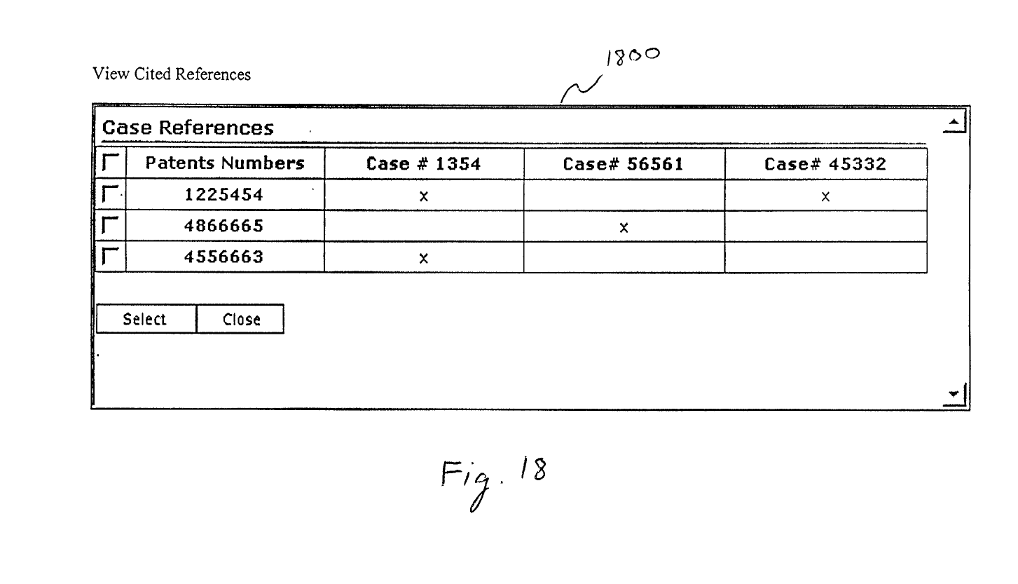

FIG. 17 illustrates an add group reference Web page 1700 useful for associating electronic documents from one case to another case according to one embodiment of the present invention. Add group reference page 1700 displays the electronic reference documents associated with the cases in the selected case list of FIG. 16. The electronic reference documents may be displayed in three categories: U.S. Patent Documents 1710, Non-U.S. Patent Documents 1720, and other references 1730 (e.g. publications, or non-patent literature). Each electronic reference document may be displayed in a row beginning with the case number to which the electronic document is currently associated. The electronic documents for each case may be displayed as links to the actual electronic documents stored in a local or remote database, and may also be displayed with other information about the electronic reference document. Other information may include patentee, date of publication, earliest effective filing date, whether or not the reference was cited to a patent office in the case it is currently associated with, and whether a translation is available.

For example, case number 112855, used for illustration only, is associated with a U.S. Patent “abc123,” a Non-U.S. Patent “abc123,” and a non-patent document “123.” It is to be understood that the names “abc123” are for illustrative purposes only, and in an actual application the U.S. Patent and Non-U.S. Patent would almost surely have different patent numbers. If a user determined that one or more of these references was relevant to the active case (i.e., the active case in the trifold from which the user accessed the add group reference page 1700), then the user could mouse click select boxes for each reference, and then mouse click the “Select” button 1740. As a result, the selected references would become associated with the active case, and could thus be incorporated into an electronic IDS for the active case for submission to a patent office. Web page 1700 also includes a “Cancel” button for canceling previously selected and associated cases.

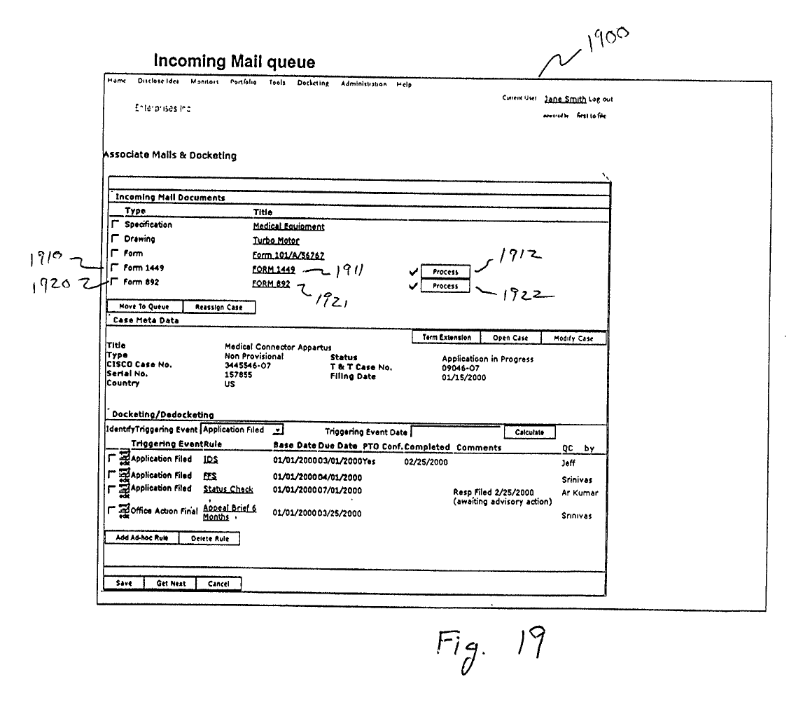

According to one embodiment, a “View Cited References” button 1750 is provided to generate a case reference report. FIG. 18 shows a case reference report Web page 1800 according to one embodiment of the present invention. The case reference report displays document references for the multiple electronic documents associated with multiple cases. For example, according to one embodiment, all the references associated with a given number of cases are displayed along the first row of an array. The first column is entitled “Patent Numbers.” Additional columns are titled to identify each case (e.g., cases can be identified by case number, title, inventor, patent application serial number, etc.), so that the number of additional columns equals the number of cases of interest. Intersecting rows, corresponding to electronic reference documents, and columns, corresponding to cases, include some form of marker when the electronic reference document corresponding to the row is associated with the case for the column.

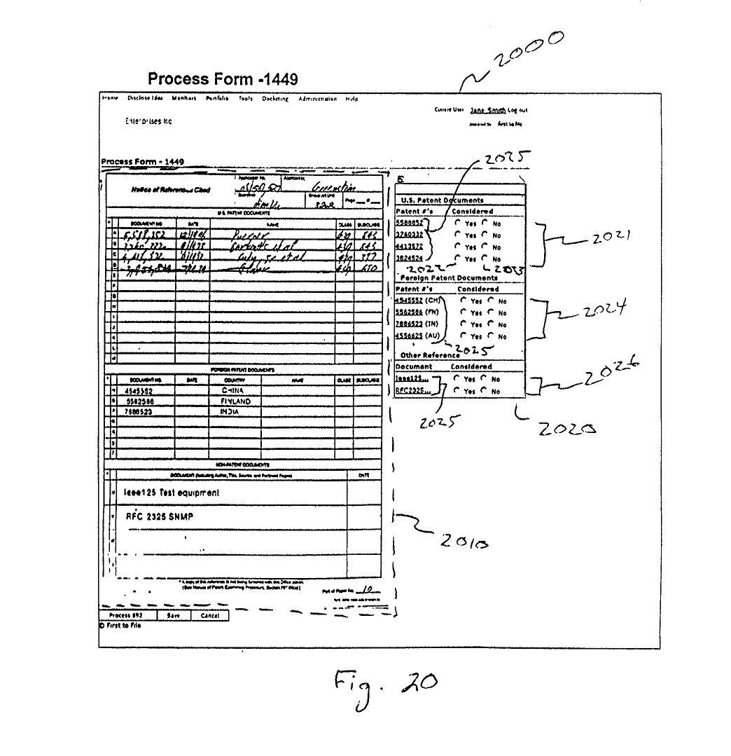

Another feature of the present invention particularly useful for managing electronic documents and information disclosure statements is illustrated in FIGS. 19-21. During prosecution of patent applications, various forms may be transmitted between a patent applicant and a patent office. For instance, when citing references to a patent office, an applicant may be required to use a particular form document, such as a form 1449 in the United States Patent and Trademark Office (USPTO). Of course, other analogous forms may be required by the Japanese Patent Office, European Patent Office, or PCT. On the other hand, when a patent examining or search authority in a patent office, such as the USPTO, discovers a reference, the patent office may be required to use another particular for document, such as a form 892 in the USPTO. However, the constant flow of forms back and forth between a patent applicant and a patent office can lead to errors in ensuring that all relevant art has been properly cited. Managing large volumes of patent application cases across multiple patent offices around the world acts to compound the problems and increase the likelihood of a potentially severe error. Thus, embodiments of the present invention provide a technique for managing form documents transferred between the patent applicant and a patent office.

According to one embodiment of the present invention, electronic reference documents containing reference information to be disclosed to a patent office may be stored on a server system, such as IP data processing system 1100. An electronic document containing citation information, such as a form 1449 or 892 in electronic form may also be received on the server system. The electronic document may contain citation information or a number of prior art reference documents either discovered by a patent office (e.g., form 892 from the USPTO) or cited by a patent applicant (e.g., form 1449 to the USPTO). Of course, in the case of a form 1449, it is to be understood that a patent applicant submits the form, and the USPTO returns the form with an indication of whether or not each of the references cited in the form was considered by the patent office. However, this is only one example. Additionally, the electronic document containing citation information may be received as an image file, for example, or in some other electronic form.

Thus, according to one embodiment of the present invention, the citation information in the electronic document received from the patent office for a case is displayed to a user of a client system in a first display section. Additionally, a plurality of identifiers corresponding to the electronic reference documents associated with the case are displayed in a second display section. A user may simultaneously view and analyze the citation information, and then enter information corresponding to the relation between the displayed citation information and the displayed plurality of identifiers into the server system using input select elements, such as select boxes, select circles, electronic buttons, or other types of commonly known input techniques. By providing the user with an interface where citation information from a patent office can be viewed alongside electronic reference document identifiers, a user may efficiently input information into the system to reconcile and manage the information in an IP data processing system with the information at a patent office.

FIG. 19 illustrates an incoming mail queue Web page 1900 according to one embodiment of the present invention. The incoming mail queue page 1900 is used to review mail received by IP data processing system. The incoming mail queue may be incoming electronic mail, or alternatively, incoming paper mail that has been scanned into the IP data processing system as an electronic image file document. Exemplary electronic document 1910 (e.g., form 1449 notice of references cited by patent applicant) and 1920 (e.g., form 892 notice of references cited by patent office) have been received in the mail queue. The mail queue may include links 1911 and 1921 to access the actual image files for each document that are stored in a database. When a user is reviewing incoming mail, a user may wish to view and analyze each of the electronic documents 1910 and 1920. If a user mouse clicks “Process” button 1912, then the user may process the form 1449.

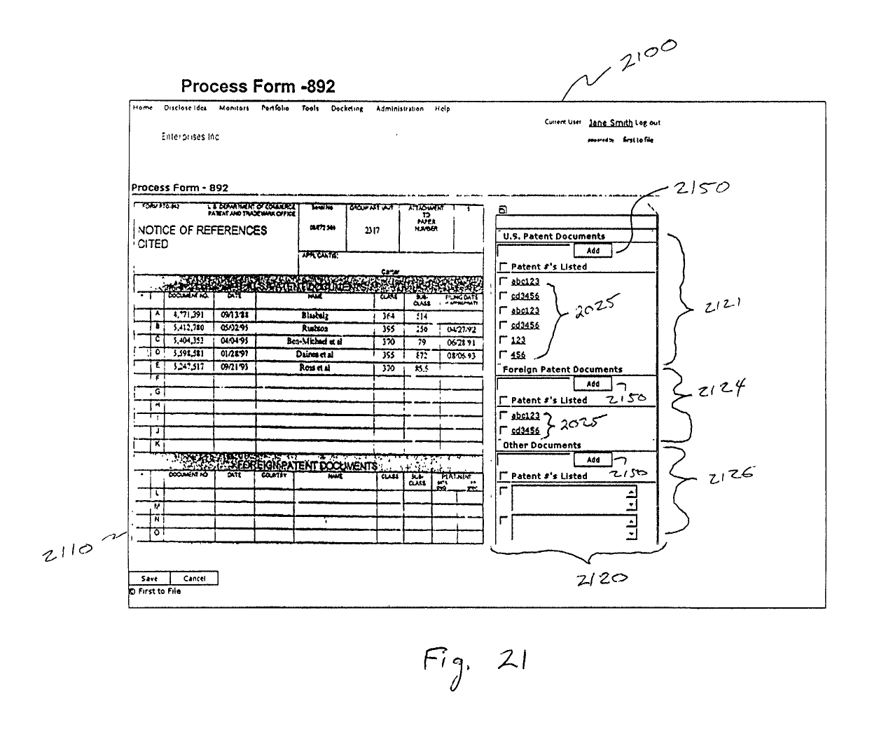

FIG. 20 illustrates a method of managing information disclosure statements according to one embodiment of the present invention. Process form 1449 Web page 2000 includes a first display section 2010 for displaying an image file of a form 1449. Process page 2000 also includes a second display section 2020 for displaying links 2025 (e.g., patent numbers, document titles) to the electronic reference documents associated with the case corresponding to the form 1449. The electronic reference documents are displayed in three sub-sections 2021 for U.S. Patent Documents, 2024 for Foreign Patent Documents, and 2026 for other non-patent documents. Of course, other identifiers such as patent application serial numbers could be used. A user may advantageously view and analyze the form 1449 along with the document links to determine whether or not additional information needs to be entered into the IP data processing system. For example, a user may review each cited reference in the form 1449, and enter information corresponding to whether or not a patent office has considered the reference by mouse clicking the input select elements (e.g., yes and no select inputs such as check boxes or check circles) for each of the document links 2050. Thus, when the yes check box is mouse clicked by the user, the information entered into the system indicates that the form 1449 indicates that the electronic reference document corresponding to the yes check box has been considered by a patent office, and when the no check box is mouse clicked by the user, the information indicates that the electronic reference document corresponding to the no check box has not been considered by the patent office. If neither yes nor no is mouse clicked, then the form 1449 indicates that the reference has not yet been considered by the patent office.

FIG. 21 illustrates a method of managing information disclosure statements according to another embodiment of the present invention. Process form 892 Web page 2100 includes a first display section 2110 for displaying an image file of a form 892. Process page 2100 also includes a second display section 2120 for displaying links 2025 (e.g., patent numbers, document titles) to the electronic reference documents that have previously been associated with the case. The electronic reference documents are displayed in three subsections 2121 for U.S. Patent Documents, 2124 for Foreign Patent Documents, and 2126 for other non-patent documents. Of course, other identifiers such as patent application serial numbers could be used. A user may advantageously view and analyze the form 892 along with the document links to determine whether or not additional information needs to be entered into the IP data processing system.

Thus, if the citation information in the form 892 indicates that a patent office has discovered additional references, then a user may enter information into the IP data processing system so that the additional references cited by the examiner are accounted for in the system. If the citation information in the form 892 includes an additional U.S. Patent, a user may mouse click “Add” button 2150. In one embodiment, the user enters the patent number in the input field 2151, clicks “Add,” the system automatically searches internal and external databases for the patent, and associates the patent with the case. In another embodiment, the user enters a link into the input field 2150 for the system to access the patent. Of course, other techniques for adding the patent to the database could be used. Similar techniques could be used to add Foreign Patent Documents and Non-Patent Publications.

These and other embodiments as well as alternatives and equivalents to the invention will be recognizable to those of skill in the art after reading the description of the present invention. The scope of the invention should not, therefore, be determined solely by reference to the above description, but instead should be determined with reference to the appended claims along with their full scope of equivalents and alternatives.

What is claimed is:

1. A computer implemented method of managing electronic documents comprising:
storing a plurality of electronic documents in a database;
associating a first one or more of the plurality of electronic documents to a first case;
associating a second one or more of the plurality of electronic documents to a second case;
receiving a select signal from a user, the select signal selecting at least one of the second one or more of the plurality of electronic documents associated with the second case to be associated with the first case; and
associating the at least one of the second one or more of the plurality of electronic documents to the first case in response to the select signal.

2. The method of claim 1 further comprising displaying the second case and links to the second one or more of the plurality of electronic patent documents to a user.

3. The method of claim 1 wherein displaying the second case further comprises displaying a third case and links to a third one or more of the plurality of electronic patent documents to a user, the third case being associate with the third one or more of the plurality of electronic patent documents.

4. The method of claim 1 further comprising displaying document references for the first and second one or more of the plurality of electronic documents associated with the first and second cases, respectively, in individual rows of a first column, and displaying first and second case identifiers at the top of second and third columns, wherein the rows of the second column include a marker when the electronic document corresponding to the row is associated with the first case, and wherein the rows of the third column include a marker when the electronic document corresponding to the row is associated with the second case.

5. The method of claim 1 wherein the first case and second case are related cases.

6. The method of claim 5 wherein the first case and second case have a common inventor.

7. The method of claim 5 wherein the first case and second case have the same assignee.

8. The method of claim 5 wherein the second case relates to a continuation patent application of the first case.

9. The method of claim 5 wherein the second case relates to a continuation-in-part patent application of the first case.

10. The method of claim 5 further comprising displaying a search screen to search for additional cases related to the first case.

11. The method of claim 1 wherein at least one of the plurality of electronic documents is an electronic version of a United States Patent.

12. The method of claim 1 wherein at least one of the plurality of electronic documents is an electronic version of a foreign patent document.

13. The method of claim 1 wherein at least one of the plurality of electronic documents is an electronic version of a publication.
